(19) United States
(12) Patent Application Publication
(10) Pub. No.: US 2026/0312741 A1
(43) Pub. Date: Oct. 8, 2026

(54) SYNCHRONIZATION ACROSS MULTIPLE SENSOR SYSTEMS

(71) Applicant: MatrixSpace, Inc., Burlington, MA (US)

(72) Inventors: Matthew T. Kling, Uxbridge, MA (US); Nihar Nanda, Burlington, MA (US)

(21) Appl. No.: 19/172,162

(22) Filed: Apr. 7, 2025

(51) Int. Cl. H04L 5/00; G01S 19/39; H04L 7/00

(52) U.S. Cl. CPC H04L 5/0005; G01S 19/39; H04L 7/0025

(57) ABSTRACT

A method in an illustrative embodiment comprises establishing, in each of a plurality of sensors of each of one or more sensor systems in communication with a central system, frequency synchronization to a corresponding frequency reference and time synchronization to a corresponding time reference at a first level of time synchronization, and establishing a second level of time synchronization, finer than the first level of time synchronization, between each of the sensors of each of the one or more sensor systems, utilizing time steps that are generated based on the corresponding frequency reference and time aligned with the corresponding time reference. The method further comprises defining multiple time slots in accordance with the second level of time synchronization, for use by sensors of the one or more sensor systems, and monitoring, by each of the one or more sensor systems, local synchronization status of the sensors of that sensor system.

### TECHNICAL FIELD

Aspects of the present disclosure relate to sensor systems, and more particularly to synchronization in sensor systems.

### BACKGROUND

Numerous types of next generation transportation are envisioned for operation in low airspace, such as less than about 5000 feet above ground level, in order to reduce ground congestion, lower delivery costs and provide other efficiencies. For example, autonomous and semi-autonomous drones, electric vertical take-off and landing (eVTOL) aircraft, and fixed-wing aircraft in low airspace are increasingly coming into operation in many urban and semi-urban areas. It is crucial in these and other next generation transportation arrangements to provide accurate object tracking and surveillance, as well as safety and security of operations, for improved usability of low airspace, thereby driving commercial growth of these important emerging technologies. Unfortunately, conventional approaches, such as use of single or multiple long-range radar systems, suffer from serious drawbacks, including excessive cost, vulnerability to ground obstructions such as terrain and buildings, and generation of excessive amounts of radio frequency (RF) interference.

Multi-modal sensor systems can avoid some of these drawbacks, but present other significant challenges, such as difficulties in achieving sufficiently precise time synchronization between multiple distributed sensor systems in a manner that permits highly accurate object tracking across different fields of view of different sensor modalities. For example, conventional time synchronization approaches utilizing Global Positioning System (GPS) or Network Time Protocol (NTP) are generally unable to support the desired level of object tracking accuracy, particularly in multi-modal sensor systems.

A need therefore exists for an improved synchronization approach that can provide more precise frequency and timing control, supporting highly accurate coordinated tracking across multi-modal sensor systems and other distributed arrangements of multiple sensor systems.

### SUMMARY

Illustrative embodiments disclosed herein provide techniques for synchronization across multiple sensor systems, one or more of which may comprise multi-modal sensor systems having multiple distinct sensor modalities.

For example, in some embodiments, each multi-modal sensor system comprises a radar, and one or more other sensor modalities, such as an optical sensor, an infrared (IR) sensor, a thermal sensor and/or another type of sensor. The disclosed techniques can illustratively provide highly accurate time synchronization for transmitting and receiving sensor signals across the multiple radars of the multi-modal sensor systems, as well as the other sensor modalities, in some embodiments to nanosecond scale (e.g., 100 ns, 10 ns, 1 ns).

These and other embodiments can advantageously support highly accurate coordinated tracking across different fields of view of the multi-modal sensor systems, even when the sensor systems are geographically dispersed relative to one another, while also avoiding the above-noted drawbacks of conventional approaches.

In one embodiment, a method comprises establishing, in each of a plurality of sensors of each of one or more sensor systems configured for communication with a central system, frequency synchronization to a corresponding frequency reference and time synchronization to a corresponding time reference at a first level of time synchronization. The method also comprises establishing a second level of time synchronization, finer than the first level of time synchronization, between each of the sensors of each of the one or more sensor systems, utilizing time steps that are generated based on the corresponding frequency reference and time aligned with the corresponding time reference. The method additionally comprises defining a plurality of time slots in accordance with the second level of time synchronization, wherein different sensors of the one or more sensor systems transmit and/or receive sensor signals in different ones of the time slots. The method further comprises monitoring, by each of the one or more sensor systems, local synchronization status of the sensors of that sensor system, and triggering reestablishment of synchronization of the sensors of that sensor system responsive to detection of an above-threshold time alignment difference between the sensors.

In some embodiments, the method further comprises monitoring, by the central system, global synchronization status across the one or more sensor systems, and triggering reestablishment of synchronization of at least one of the one or more sensor systems responsive to detection of an above-threshold time alignment difference between the central system and the at least one of the one or more sensor systems.

In some embodiments, the central system and the one or more sensor systems comprise respective nodes of a distributed sensor network, with the central system comprising at least one of a central server and a central gateway, although numerous alternative arrangements are possible. Accordingly, the term “central system” as used herein is intended to be broadly construed, and should not be interpreted as requiring any particular geographic or spatial relationship relative to the sensor systems. For example, in some embodiments, the central system may be implemented at least in part on the same processing platform as at least one of the sensor systems.

The one or more sensor systems in some embodiments illustratively comprise a plurality of geographically-dispersed sensor systems.

As indicated previously, the sensor systems in some embodiments illustratively comprise respective radars. Each of the radars illustratively transmits and receives a plurality of chirp signals within corresponding assigned ones of the time slots, with different ones of the chirp signals of different ones of the radars being synchronized with one another to the second level of time synchronization maintained across the sensor systems.

Additionally or alternatively, at least a subset of the sensor systems may comprise respective multi-modal sensor systems that each include at least one radar and at least one additional sensor of a different sensor modality. For example, the additional sensor may comprise at least one of an optical sensor, an IR sensor and a thermal sensor.

It is to be appreciated that the foregoing arrangements are only examples, including examples of potential applications of the disclosed techniques, and numerous alternative arrangements are possible.

These and other illustrative embodiments include but are not limited to systems, methods, apparatus, processing devices, integrated circuits, and computer program products comprising processor-readable storage media having software program code embodied therein.

### BRIEF DESCRIPTION OF THE FIGURES

FIG. 1 is a block diagram of an example information processing system incorporating synchronization functionality for multi-modal sensor systems with radars in an illustrative embodiment.

FIGS. 2 through 5 are block diagrams showing details of example implementations of the FIG. 1 system.

FIG. 6 is a block diagram showing example interactions between a global time synchronizer of a central system and a plurality of sensor time synchronizers of respective sensor systems in an illustrative embodiment.

FIGS. 7 and 8 show more detailed views of respective global and sensor time synchronizers in illustrative embodiments.

FIG. 9 shows another view of communication between a global time synchronizer and multiple sensor time synchronizers in an illustrative embodiment.

FIG. 10 is a flow diagram of an example two-level time alignment process implemented in a global time synchronizer in an illustrative embodiment.

FIG. 11 is a flow diagram of an example fine time synchronization process implemented in each of a plurality of sensor time synchronizers in an illustrative embodiment.

FIG. 12 is a block diagram of another example information processing system incorporating synchronization functionality for sensor systems with radars in an illustrative embodiment.

FIG. 13 is a timing diagram showing an example arrangement of time slots in accordance with a time synchronization arrangement implemented across multiple sensor systems in an illustrative embodiment.

FIG. 14 is a flow diagram of an example synchronization process for sensor systems with radars in an illustrative embodiment.

### DETAILED DESCRIPTION

Illustrative embodiments can be implemented, for example, in the form of information processing systems comprising a central system and one or more sensor systems, each of which may be implemented as at least a portion of a “processing platform” as that term is broadly used herein. A number of examples of such information processing systems will be described in detail herein. It should be understood, however, that embodiments disclosed herein are more generally applicable to a wide variety of other types of information processing systems and associated central systems, sensor systems, sensors and other components. Accordingly, the term “information processing system” as used herein is intended to be broadly construed so as to encompass these and other arrangements.

As indicated previously, numerous types of next generation transportation are envisioned for operation in low airspace, such as less than about 5000 feet above ground level, in order to reduce ground congestion, lower delivery costs and provide other efficiencies. For example, autonomous and semi-autonomous drones, eVTOL aircraft, and fixed-wing aircraft in low airspace are increasingly coming into operation in many urban and semi-urban areas. It is crucial in these and other next generation transportation arrangements to provide accurate object tracking and surveillance, as well as safety and security of operations, for improved usability of low airspace, thereby driving commercial growth of these important emerging technologies. Unfortunately, conventional approaches, such as use of single or multiple long-range radar systems, suffer from serious drawbacks, including excessive cost, vulnerability to ground obstructions such as terrain and buildings, and generation of excessive amounts of RF interference. Multi-modal sensor systems can avoid some of these drawbacks, but present other significant challenges, such as difficulties in achieving sufficiently precise time synchronization between multiple distributed sensor systems in a manner that permits highly accurate object tracking across different fields of view of different sensor modalities, particularly when multiple sensor systems are geographically dispersed relative to one another.

Illustrative embodiments disclosed herein advantageously address and overcome these and other problems of conventional approaches by providing an improved synchronization approach that can provide more precise frequency and timing control, supporting highly accurate coordinated tracking across multi-modal sensor systems and other distributed arrangements of multiple sensor systems.

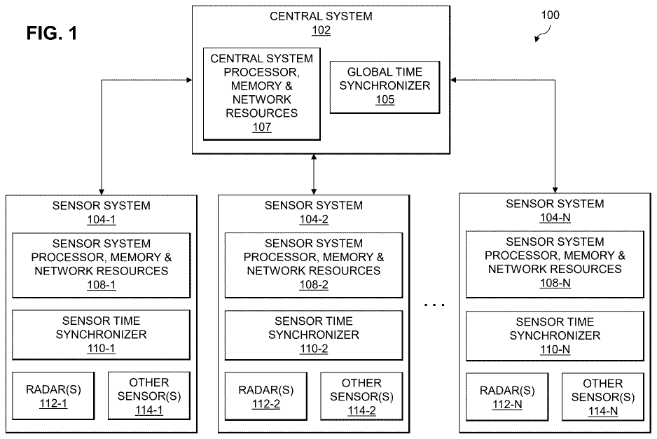

FIG. 1 shows an example information processing system 100 incorporating synchronization functionality for multi-modal sensor systems with radars in an illustrative embodiment. The information processing system 100 comprises a central system 102 configured for communication with a plurality of sensor systems 104-1, 104-2, . . . 104-N, collectively referred to herein as sensor systems 104, where N is an integer greater than or equal to one. The central system 102 and the sensor systems 104 in some embodiments illustratively comprise respective nodes of a distributed sensor network or other type of distributed system. In some embodiments, the central system 102 more particularly comprises at least one of a central server and a central gateway of the information processing system 100, although additional or alternative arrangements can be used in implementing the central system 102. The sensor systems 104 illustratively comprise a plurality of geographically-dispersed sensor systems, although again other arrangements can be used.

Although multiple sensor systems 104 are illustratively shown in FIG. 1, this is by way of example only, and other embodiments can include only a single sensor system. Also, a given such sensor system can include only a single sensor, such as a single radar 112 or a single instance of another sensor of a different type.

The central system 102 comprises a global time synchronizer 105 which is implemented utilizing at least portions of central system processor, memory and network resources 107. For example, the central system processor, memory and network resources 107 may comprise one or more processing devices, each comprising at least one processor coupled to at least one memory, and configured to communicate with other system components over one or more networks. Such processing devices are illustratively part of at least one processing platform of the information processing system 100, and can be used to implement the global time synchronizer 105, for example, in the form of software, firmware and/or hardware.

The sensor systems 104-1, 104-2, . . . 104-N comprise respective sets of sensor system processor, memory and network resources 108-1, 108-2, . . . 108-N. At least portions of these sets of sensor system resources are utilized to implement respective sensor time synchronizers 110-1, 110-2, . . . 110-N, also referred to herein as respective local time synchronizers of the respective sensor systems 104. For example, the sensor system processor, memory and network resources 108 may each comprise one or more processing devices, each including at least one processor coupled to at least one memory, and configured to communicate with other system components over one or more networks. Such processing devices are illustratively part of at least one processing platform of the information processing system 100, and can be used to implement the sensor time synchronizers 110, for example, in the form of software, firmware and/or hardware. In some embodiments, the central system 102 can be implemented on the same processing platform as at least one of the sensor systems 104.

The sensor systems 104 further comprise one or more radars 112-1, 112-2, . . . 112-N, and one or more other sensors 114-1, 114-2, . . . 114-N, respectively. The one or more radars 112-1 and the one or more other sensors 114-1 are local to the sensor system 104-1. Similarly, the one or more radars 112-2 and the one or more other sensors 114-2 are local to the sensor system 104-2, and the one or more radars 112-N and the one or more other sensors 114-N are local to the sensor system 104-N. For example, the sensor systems 104 in some embodiments are geographically dispersed relative to one another, with the radar(s) and other sensor(s) of a given one of the sensor systems 104 being local to that sensor system but geographically remote from the other ones of the sensor systems 104. Terms such as “local” and “remote” in this context and other contexts herein are intended to be broadly construed. For example, the radar(s) and other sensor(s) of a given one of the sensor systems 104 are referred to as “local” to that sensor system in that those components are assumed to be part of or otherwise directly associated with the given sensor system.

Although the sensor systems 104 are each illustrated as including at least one radar 112 and at least one other sensor of another modality, this is by way of example only, and a given such sensor system can instead include, for example, only a single radar or multiple radars, and no other sensors of any other modality.

Sensor signals from the radars 112 and other sensors 114 of the sensor systems 104 are illustratively returned to the central system 102 for further processing. For example, the central system 102 can perform sensor fusion operations to combine sensor signals from different ones of the radars 112 and other sensors 114. Additionally or alternatively, at least portions of such sensor fusion processing can be performed in one or more of the sensor systems 104 utilizing sensor systems from their respective ones of the radars 112 and other sensors 114.

In some embodiments, each of the sensors of each of the sensor systems 104, illustratively under the control of its corresponding one of the local sensor time synchronizers 110, which interacts with the global time synchronizer 105 of the central system 102, establishes frequency synchronization to a corresponding frequency reference and time synchronization to a corresponding time reference at a first level of time synchronization. A second level of time synchronization, finer than the first level of time synchronization, is then established between each of the sensors of the sensor systems 104, illustratively with involvement of the global time synchronizer 105 of the central system 102, utilizing time steps that are generated based on the corresponding frequency reference and time aligned with the corresponding time reference. For example, in some embodiments, the local sensor time synchronizer of a given one of the sensor systems 104, in cooperation with the global time synchronizer 105, is illustratively configured to control each of the sensors of the given sensor system to achieve the second level of time synchronization. In some embodiments, each of the global time synchronizer 105 and the sensor time synchronizers 110 achieves the first and second levels of time synchronization, although other arrangements are possible.

A plurality of time slots are illustratively defined in accordance with the second level of time synchronization, wherein different sensors of the sensor systems 104 transmit and/or receive sensor signals in different ones of the time slots. For example, the time slots illustratively comprise time-division multiple access (TDMA) slots of a TDMA frame, with different ones of the time slots being assigned to different ones of the sensors. The radars of the respective sensor systems 104 illustratively each transmit and receive one or more chirp signals within one or more assigned ones of the time slots. The one or more other sensors similarly transmit and/or receive one or more sensor signals in their respective one or more assigned time slots.

Each of the sensor systems 104, via its corresponding sensor time synchronizer, monitors local synchronization status of the sensors of that sensor system, and triggers reestablishment of synchronization of the sensors of that sensor system responsive to detection of an above-threshold time alignment difference between the sensors.

Additionally, in some embodiments, the central system 102, via its global time synchronizer 105, monitors global synchronization status across the sensor systems 104, and triggers reestablishment of synchronization of at least one of the sensor systems 104 responsive to detection of an above-threshold time alignment difference between the central system 102 and the at least one of the sensor systems 104.

The local synchronization status can include a variety of different types of information. For example, the local synchronization status of a given one of the sensors of one of the sensor systems 104 may comprise sensor timing information determined based at least in part on a count of cycles of a clock signal relative to a designated pulse of a pulse signal, with detection of an above-threshold time alignment difference being based at least in part on the sensor timing information. In some embodiments, the sensor timing information can include the count itself and/or an indication of whether the count is above or below a specified threshold, where the threshold is illustratively specified in terms of a number of clock cycles of the clock signal relative to the designated pulse of the pulse signal. Numerous other types of information indicative of sensor timing can be used, and the term “local synchronization status” as used herein is therefore intended to be broadly construed.

In some embodiments, each of one or more of the sensor systems 104 comprises a clock source configured to lock to the corresponding time reference, and an edge computer coupled to the clock source and implementing a corresponding sensor time synchronizer. The clock source and edge computer may be viewed as examples of the sensor system processor, memory and network resources 108 of the corresponding sensor system. The sensors of the sensor system comprise at least one radar 112 coupled to the edge computer and the clock source, and possibly one or more other sensors 114 of other sensor modalities, as indicated previously.

The above-noted clock source in some embodiments may comprise, for example, a phase-locked clock source providing a pulse signal and a clock signal, where the first level of time synchronization is established by the sensors of the corresponding sensor system based at least in part on the pulse signal and the second level of time synchronization is established by the sensors of the corresponding sensor system based at least in part on respective counts of cycles of the clock signal relative to a designated pulse of the pulse signal. As a more particular example, the pulse signal may comprise a one pulse per second (1PPS) signal and the clock signal may comprise a 10 MHz clock signal, although other types of pulse signals, clock signals and clock sources can be used in other embodiments.

In some embodiments, the 1PPS signal and the 10 MHz clock signal are obtained from a GPS disciplined oscillator (GPSDO) driven by an output of a GPS receiver. Additional or alternative clock sources that can be used in some embodiments include NTP units. A similar clock source illustratively based on GPS and/or NTP is assumed to be implemented in the central system 102. Such a clock source illustratively provides an indication of absolute time as well as the above-noted pulse signal and clock signal, and is implemented in the central system 102 and each of the sensor systems 104.

The global time synchronizer 105 in some embodiments is configured to maintain synchronization across all of the potentially geographically-dispersed sensor systems 104 of the system 100. The local sensor time synchronizers 110 in respective ones of the sensor systems 104, in cooperation with the global time synchronizer 105, are configured to maintain synchronization between their respective sets of sensors.

Time synchronization in the system 100 is illustratively achieved utilizing a hierarchical process, with the first level of time synchronization being at a relatively coarse level (e.g., a millisecond scale) and the second level of time synchronization being at a finer scale (e.g., a nanosecond scale), such that all of the sensors of the system 100 are synchronized to the second level of time synchronization.

In some embodiments, the disclosed synchronization techniques provide highly coordinated transmit and receive timing synchronization, facilitating unique TDMA signaling approaches across multiple geographically-dispersed radars and/or other types of sensors in a distributed sensor network. For example, such arrangements can advantageously combine detection signals across all of the sensors in a common coordinate system to treat the entire sensor network as a single field of view. These and other embodiments can extend the range of the distributed sensor network, while also increasing its accuracy and resiliency, and simplifying tracking handoffs.

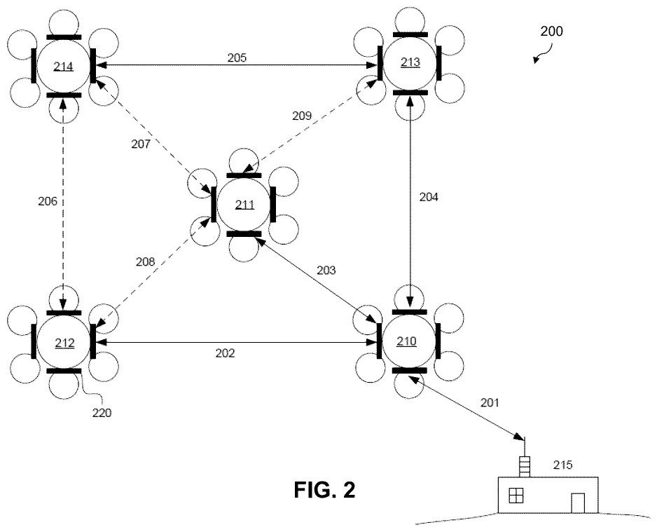

FIGS. 2 through 5 show details of example implementations of the FIG. 1 system. In some of these implementations, the sensor systems illustratively comprise respective AI drones, each of which may be equipped with one or more radars and/or other types of sensors. The sensor gateways referred to in these embodiments may be viewed as examples of the central system 102, and the AI drones or sensor units may be viewed as examples of the sensor systems 104. It is to be appreciated that these are just examples of system implementations that can be configured to incorporate the synchronization functionality disclosed herein. A wide variety of other system implementations can be used in other embodiments.

FIG. 2 shows a network 200 comprising aerial drones 210-214 forming a mesh network of links 201-209. Each of the drones 210-214 may comprise one or more phased array antennas 220, where the number of antenna arrays may ensure full 360° coverage. The network has a root at a ground or base station 215, which is shown as a static location but could also itself, be mobile. Dashed line links 206-209 represent alternate links between drones. Each drone acts as a node in the network. It is not required that all nodes operate at the same frequency, and, to avoid interference between nodes that are lined up such that a third further node is in the peak energy beam of a radio link between a first and second node, the network may employ several alternate neighboring frequencies.

Illustrated in FIG. 2 is a drone swarm of unmanned aerial drones. Each drone in the swarm is also a communications node and is equipped with one or more phased array, electrically steerable antennas and a transceiver operating in the millimeter wave region. Each drone may also be equipped with one or more sensors, such as radar, optical, LIDAR, thermal, or acoustic sensors. The drones carry an on-board processor and memory for controlling the drone's movements, operating the sensors, and managing the transceiver. The drones also carry antennas and a processor for determining position based on satellite data (e.g., GPS or the like) and optionally an on-board inertial and magnetic (compass) sensor. The drones communicate with each other to form a mesh network of communication nodes with an RF link back to a root node, base station, or other target node in the network. The nodes respond to interference from jammers and obstacles by finding new paths through the mesh, steering the millimeter wave beam, repositioning, or a combination of these techniques.

Path loss of a radio link increases proportional to the square of frequency. For example, going from 2.4 GHz which is roughly a common frequency for cell phones and 2.4 GHz WiFi to 24 GHz would result in a path loss that is 100 times higher, or 20 dB. Going from 2.4 GHz to 80 GHz would have a 30 dB increase in path loss. In a free space propagation condition, the path loss increases by 20 dB for every decade of distance. Therefore, going from 2.4 GHz to 24 GHz would reduce the link distance by a factor of 10, and the link distance for an 80 GHz link would decrease by a factor of 33. However, high frequencies have the benefit of very wide bandwidths and thus faster data rates. Additionally, the size of the antenna decreases with frequency (wavelength), enabling the use of more complex, higher gain antennae to combat the increase in path loss. Higher gain results from focusing the energy, thereby resulting in highly directional antennas.

The phased array antenna consists of numerous antenna that have their amplitude and phase adjusted to steer the beam by adjusting summation and cancellation of signals from various directions. The focusing of the energy, often in both azimuth and elevation, creates a higher gain antenna. However, the very focused beam is preferably pointed in the right direction to facilitate communication. Additionally, the focusing of the beam means the transmission/reception in directions away from the main beam is attenuated, which may enable the avoidance of interference.

Furthermore, the phased antenna arrays may help with isolation of communication channels such as transmitting in one direction and receiving in another. Phased array antennae utilize software to control the gain/phase of each antenna element for steering of the beam, where the system is aware of which direction to steer the beam. The beams may be steered by knowledge of relative GPS locations or drone formation which may be known based on a flight plan or shared over a communications link. The beams may also be steered by scanning the beam and/or with closed-loop tracking. One typical implementation of a phased array antenna uses a planar array of patch antenna elements. This has the advantage of being flat and thus can fit well onto an aircraft without significant size and aerodynamic implications.

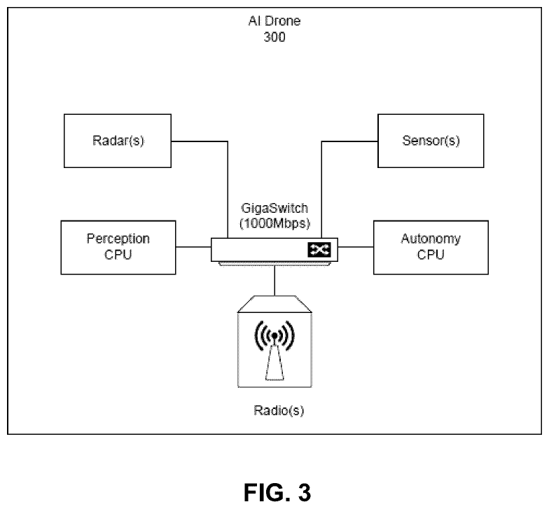

FIG. 3 shows an example drone that may be configured for improving radar angular resolution in accordance with an example embodiment of the disclosure. Shown in FIG. 3 is an aerial drone 300.

The drone 300 may comprise suitable circuitry and other components (e.g., hardware or otherwise) to facilitate operation in accordance with the present disclosure. For example, the drone 300 may comprise radar(s), other sensor(s), communication module(s), and processors (e.g., central processing unit (CPU) processors, graphics processing unit (GPU) processors, etc.). In some instances, the drone 300 may be configured to facilitate or support use of advanced computing/processing based operations, such as artificial intelligence (AI) based operations. In this regard, circuitry and other components (e.g., hardware or otherwise) embedded in (or otherwise made available to) the drone 300 may be configured to support various advanced computing based tasks, such as real-time AI computing/processing and data analytics, which may be used in conjunction with radar angular resolution related functions.

For example, as shown in FIG. 3, the drone 300 comprises a perception processor/circuit (or CPU), an autonomy processor/circuit (or CPU), radio(s), radar(s) and other sensor(s) for obtaining sensory related data, and a switch for facilitating interactions among the various elements of the drone 300. The perception processor/circuit (or CPU) and the autonomy processor/circuit may be configured to facilitate and support, inter alia, AI based sensing, data fusing, and data sharing functions, as described herein. The radio(s) may be configured for supporting communications by the drone 300, such as, e.g., with other AI drones and/or other network elements within a mesh network comprising the drone 300. The disclosure is not limited to any particular type(s) of radio(s), and various types may be used so long as suitable for operation in a drone-based environment. In an example implementation, mesh based radios that may be optimized for supporting forming and operating mesh networks of drones are used. The radars may be configured to provide radar based detection, using known radar detection techniques. The sensors may be configured to obtain sensory data that may augment radar based data. The sensors may be configured to support, e.g., automatic dependent surveillance-broadcast (ADS-B) based sensory, camera feed, thermal imaging, etc.

In some instances, drones such as the drone 300 may be configured for improved data communications in drone based mesh networks. As noted, the drone 300 may incorporate advanced radios such as radar/communication module(s), such as mesh based radios, which may support improved data communication. For example, the radar/communication module(s) may support high-speed long-range data (e.g., >200 Mbps up to 1 km), may have large field of view (e.g., 120° in azimuth and elevation). The radar/communication module(s) may support use of secure data link(s) (e.g., with AES-256 encryption).

In some instances, drones such as the drone 300 may be configured to provide and/or support use of local high bandwidth mesh to enable the drone to connect to other drones and/or network devices. Such local mesh may allow for connecting to drones, fixed sites (e.g., sensor(s) with radios), police cruisers, sensors, etc. For example, mesh connectivity may be provided using 24 GHz phased array, which may allow for communication at, for example, 400 Mbps at 600 m, 200 Mbps at 1 km, and/or 2 Mbps at 20 km. Local device connectivity may be provided using 802.11n dual band, which may allow up to 10 WiFi users (e.g., at 433 Mbps), and/or via wired Ethernet for expanded users. Such mesh connectivity may be suitable for various use applications, such as distributed sensor networks, sensor fusion applications, etc.

In some instances, drones such as the drone 300 may be configured to form and/or operate within a sensor mesh. In such instances, some of the drones may comprise high performance embedded CPU and GPU processor(s) for use in data processing, particularly in conjunction with handling processing and fusing gather sensory data.

In some instances, drones such as the drone 300 may be configured to support various advanced computing based tasks, such as real-time AI and data analytics, which may be used in conjunction with radar angular resolution related functions. In this regard, the drone 300 may be configured to provide software defined AI sensing and autonomous responses. This may be particularly possible and/or optimized in conjunction with the radar angular resolution related functions. In this regard, such AI based solutions may include and/or entails use of AI sensing, AI autonomy, and AI cloud services. With respect to AI sensing, data acquisition may be performed using advanced (e.g., mesh based) radars/radios. In this regard, formed RF meshes may enable new levels of data sharing for distributed sensing. Such radars may be optimized for drones or handheld devices. AI software may fuses optical and radar (data), such as using AI deep learning. The software may integrate data from 3rd party optical, LIDAR, thermal/IR and other sources as needed. Sensors may be handheld, ground based, and/or deployed on drones. The implementation of the disclosed software and/or sensing enables multiple object classification & tracking, even in foggy or smoky conditions.

AI autonomy may be utilized when acting on acquired data. Sensors, people, vehicles and drones may coordinate data in real-time through RF mesh network. Autonomy software may be used to enable and ensure autonomous drone response and provide AI based assistance to operators. This may allow for multiple object classification and tracking, even in low visibility (e.g., foggy or smoky) conditions. Automated drones may extend sensing over distance and rapidly inspect areas of interest. This may allow for intelligent detect and avoid, or detect and track navigation. In some instances, sensor data may be rendered into detailed three-dimensional (3D) models (e.g., terrain, structures, areas of interest, etc.). The use of such service may also allow for detecting safety hazards (e.g., in structures, terrain, certain locations, etc.), and/or detecting safety/security issues. In some instances, open architecture may be used/supported to enable running or incorporate applications from different sources (e.g., combining provider's proprietary neural networks with user's and/or 3rd party's AI applications).

In some instances, drones such as the drone 300 may be configured for operation within network arrangements configured for other advanced and/or specialized services, such as, e.g., enabling enterprises-scale deployment of aerial vehicles, ground vehicles, fixed sensors, and more, interoperating with any existing networks using intelligent routing at the edge, and/or securing data from end-to-end using fully encrypted links (AES-256).

In accordance with the present disclosure, networks comprising drones such as the drone 300 may be configured for supporting improved radar angular resolution and overall target location ability. Overall target location ability may be improved by, e.g., fusing of radar based data with other sources (e.g., optical or the like). The improvement related measures or techniques may be implemented via a single platform or multiple platforms. In this regard, single platform based improvement may comprise one or more of: moving the platform for multiple observations, use of use of autonomous movement, use of advanced/optimized processing (e.g., AI based processing), classifying objects (e.g., for optimized detection), sharing of information with other nodes (e.g., other drones, other nodes, ground stations, the cloud, etc.), sharing of information within a mesh (comprising plurality of similar platforms), and the like. When moving the platform for multiple observations, information such as location, heading, beam, etc. may be obtained and/or recorded for each observation point. In this regard, location and heading information may be obtained using suitable sensory techniques, such as global positioning (e.g., GPS), inertial measurement unit (IMU) based sensing, and the like.

Multiple platforms based improvement may be implemented via a plurality of platforms (e.g., combination of one or more of drones, non-drone mobile nodes, fixed nodes, etc.). In this regard, in some instances the single platform based improvement techniques as described herein may be applied at one or more of the multiple platforms utilized for multiple platforms based improvement. Further, multiple platforms based improvement may comprise one or more of: simultaneous or near simultaneous use of at least some of the multiple platforms, autonomous control of at least some of the multiple platforms, coordinated operation of other platforms, flying drones in formation, moving drones for improved location ability, use of passive detection, use of active and/or passive detection from drone to drone.

The simultaneous or near simultaneous use of platforms may comprise and/or entail coordinating (and thus sharing information relating to) such operation parameters as frequency, time, code, space related parameters, or combinations thereof. Passive detection may comprise (or entail) utilizing coded chirps, and entail selecting or setting such parameters as frequency and time related parameters. Coordinated operation of other platforms may comprise, for example, having one node alerting one or more other nodes to request observation and/or coordination of actions by the one or more other nodes. This may comprise or entail sharing or coordinating such information as location(s), target, beam steering, etc. Implementations incorporating use of the improved radar angular resolution and overall target location ability as described herein may have various practical applications, e.g., in drone navigation/detection, in security solutions, in ground based perimeter, in ground vehicle based solutions, in aviation based solutions, in marine based solutions, in golfing and other sports, in local air traffic solutions. Use of such measures or techniques in improving radar angular resolution, and example use cases based thereon, are described in more detail below.

In accordance with the present disclosure, enhanced sensing solutions are provided, incorporating multi-modal sensor based systems and/or networks that are configured for supporting improved sensing in combination with edge extending, data sharing, and collaborative fusion of sensing data. In this regard, as used herein “multi-modal sensor” or “multi-modal sensing” (also referred to herein as “multi-sensor systems” and/or “multi-sensor networks”) refers to use of multiple sensors (including sensing integrating different types of sensors), to extend coverage and/or allow for enhanced sensing (e.g., by use of different types of sensors, different sensing perspectives, etc.), and/or use of sensory data obtained thereby (or information generated or obtained based thereon), particularly where the sensory data is fused in real-time or near-real-time, and/or where the data fusing may be done in collaborative manner and/or using advanced processing techniques, such as AI processing. The amount time or scale of timeliness that may be construed as constituting real-time or near-real-time may vary based on the application. In this regard, actual real-time may be difficult with AI technologies available nowadays, and as such fusing of data may only be possible in near-real-time. For example, milliseconds may be considered real-time in some systems or some applications, whereas for other systems or applications (e.g., radars synchronization) real-time may have scale in the nanoseconds.

Solutions based on the present disclosure may address various issues and/or limitations in existing and/or conventional solutions. In this regard, one commonly used type of sensors is optical sensors, such as cameras, which may be used to detect and track objects on the ground or in the air for security and surveillance (e.g., monitoring). Cameras may be used in security and surveillance where a centralized or cloud server is used to collect all data, with operators monitor sensor streams to recognize when something of interest is taking place. However, use of cameras may have shortcomings, as use of cameras may be challenging with low light, under certain conditions (e.g., smoke or fog), and the like. Further, camera based solutions lack support for sensor fusion, and offer limited object recognition and tracking. Another commonly used type of sensors is radar, which may be used to, e.g., detect and track objects, such as objects on the ground for vehicle navigation, in the air for airspace monitoring, etc. For example, automotive radars may be used for short range object detection and collision avoidance or driver assistance, and airspace radars may be used for, e.g., air traffic monitoring, and military/defense applications, etc. However, use of radars may have shortcomings, as typically only single radar is used (per platform), radars may not be integrated with other sensors, and radars may be large and expensive and as such may not be compatible with small platforms. Another commonly used type of sensors is radio frequency detectors, which may be used to identify remote datalink waveform signatures. Such systems may estimate direction of arrival of signals with high amounts of error and use other sensors like optical sensors to obtain better, and/or to provide estimates of target location after initial detection. However, use of radio frequency detectors alone may have shortcomings, such as due to inadequate object recognition and inaccurate 3D position estimation.

Conventional sensing may have various limitations and/or issues. For example, use of sensors, such as for security and surveillance of physical spaces (ground or air), may have severe constraints for accurate detection and tracking of objects, particularly when utilizing a single sensor type. For example, many optical security systems rely on a human to recognize objects, and do not perform well in low light conditions. Additionally, conventional sensor networks simply pass large volumes of data to a central server without coordination across distributed fields of view and without sensor fusion to fill in gaps or enhance vision. Also, running power or data cables to widely distributed sensors is cumbersome, time-consuming, expensive, and limits scalability of the sensor network to grow and adapt to changing needs. Conventional solutions do not leverage various advancements, such as evolving sensor technologies, high-end edge computing, and AI processing (e.g., for object recognition).

Solutions based on the present disclosure may allow for leveraging such advancements, however, which may produce better results, particularly when combining multiple sensors and multiple sensor types at the edge. In this regard, current sensing solutions may be limited in performance in terms of both accuracy and coverage range. Networked, AI-enabled multi-modal sensing with multiple types of sensors (e.g., radar and optical) offers large performance gains in accuracy by sharing fields of view and combining data as well as increases in coverage area by sharing and handing off object tracking, similar to handoffs in a cellular network. Solutions based on the present disclosure may offer other improvements over existing solutions. For example, current solutions require complex installation procedures for sensor placement, providing power, and enabling communications. Security cameras, e.g., may operate using Power over Ethernet (PoE), which requires individual cables to be run and have length limitations in 100's of meters. This also limits coverage areas and deployment locations or drastically increases complexity and cost for deployment. Further, cameras may not perform well at night or in low lighting conditions and cannot see through smoke or fog. Single radar sensors do not provide good visibility. Also, radar sensors may be limited to high-end military solutions and are not Size, Weight, Power and Cost (SWaP-C) compatible with portable/mobile platforms. Sensors do not easily integrate with each other, meaning large investments in engineering costs are required. For example, combining sensors of different types requires highly specialized skillsets and knowledge.

In various example implementations based on the present disclosure, a single integrated sensor device (or sensor unit) may be used at the edge, which combines use of one or more types of sensing (e.g., advanced radar sensing and optical cameras), with use of advanced processing (e.g., AI based processing) and communications capabilities to enable real-time situational awareness observing target and movements. The single integrated sensor devices may be capable of synchronizing sensor observations and of processing accurately sensory data, in timely manner (e.g., up to milliseconds), and of generating fully coordinated sensor object detection and tracking with high degree of precision. Radar and optical sensors present in the sensor unit share a similar field of vision enabling detection and tracking accuracies with extending the range over multiple kilometers. Embedded geo-position and orientation system in the sensor unit may be used to provide accurate location and heading of the sensor unit compensating for object detection locations in real-time expanding applicability in moving and static sensor units.

The sensor units may be configured to work collaboratively in conjunction with one or more sensor gateways, forming collaborative network of multi-modal sensors, which may be used to provide access to and/or among the sensor units, and/or to support collaborative sharing and fusing of sensory data. In this regard, the sensor units may be equipped with wireless communication resources, to enable communication over secure private sensor networks set up and/or managed via the sensor gateways to enable distributing or sharing detection and tracking data (e.g., of flying or ground-based targets). The sensor gateways may be configured to fuse individual sensor device feeds, such as into shared field of vision data, generating situational awareness of tracked targets over a large area. Advanced processing techniques, such as AI processing, may be used, such as in object recognition and/or in analyzing object movement within the area, identifying individual targets, identifying possibility of threats in cases of security and surveillance applications. The sensor units with a sensor gateway may form a self-sustainable distributed single or multi-sensor system or network comprising sensors, computing resources, storage resources, and communication resources, which may be ready to be deployed for any edge application with minimal requirements creating advanced situational awareness. Such single or multi-sensor system or network may have a wide range of edge applications that may include military and defense, physical security, airspace security, airspace management, autonomous vehicles, as well as others such as sports analytics. In some instances, multiple sensor gateways may be connected (e.g., over wireless connections) within the same network, allowing for scaling of edge sensing operation over vast areas creating object tracking and threat detection.

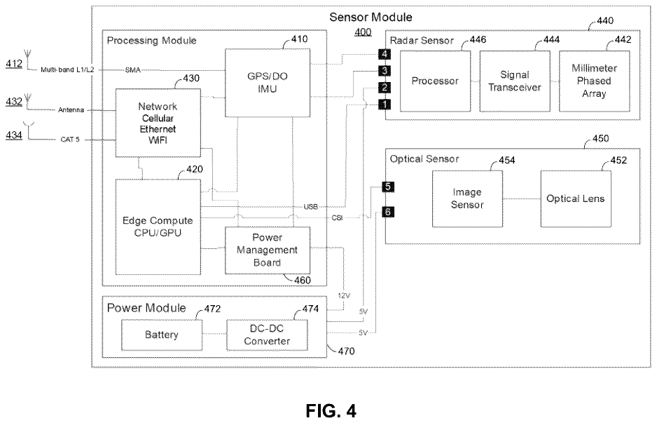

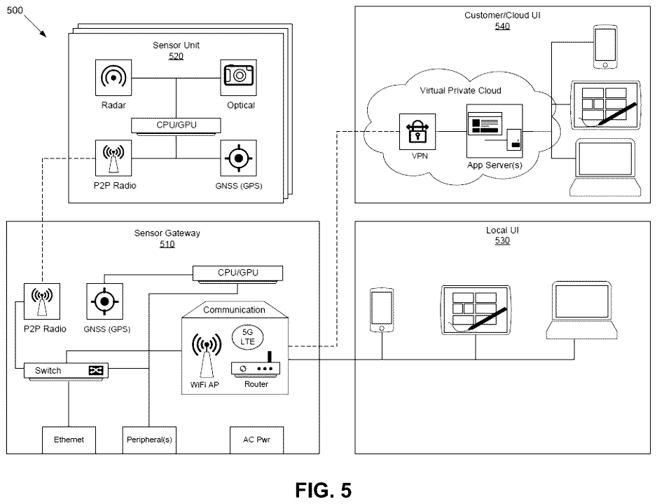

Accordingly, example implementations based on the present disclosure may incorporate one or more of such features as: 1) combined optical sensing and mmWave radar sensing extending area of coverage, allowing operations over any lighting (day, night, bright sunshine), weather conditions (rain, fog, snow) and environmental conditions (smoke, dust); 2) improved accuracies of object detection and classification with probabilistic AI object detection and 3D positioning; 3) real-time sensor fusion and combined object tracking with timing synchronization; 4) integrated private sensor network, sensor units communicate with latency and reliability; 5) options for both sub-6GHz communications and 24 GHz communications; 6) network edge extension with mm-wave beam steering; 7) GPU and multi-core CPU Edge Compute; 8) embedded GPS for real-time position; 9) embedded INS for accurate position, pose, and motion information; 10) phase locked (e.g., GPSDO) frequency and time source for synchronization; 11) flexible power sources for wide range of deployments (e.g., DC input, AC input, solar input, optional battery, etc.); 12) advanced design with choice of materials for enclosures and electronic components top operate outdoors in adverse conditions. Example implementations, and/or features associated therewith, based on the present disclosure are illustrated in, and described in more detail below with respect to FIGS. 4 and 5.

FIG. 4 illustrates an example sensor module, in accordance with the present disclosure. Shown in FIG. 4 is sensor module 400. The sensor module 400 may comprise suitable circuitry and other hardware resources for providing edge sensing functions, along with additional functions (e.g., communication, processing, etc.), and may be particularly adapted for use in mesh networking based implementations in accordance with the present disclosure.

In the example embodiment illustrated in FIG. 4, the sensor module 400 comprises a GPS/disciplined oscillator (GPS/DO) unit 410, edge compute CPU/GPU 420, a network board 430, a radar sensor 440, an optical sensor 450, power management board 460, and a power module 470. Each of these elements may comprise suitable circuitry for performing functions or operation associated therewith.

The GPS/DO unit 410 may comprise circuitry for a combination of a GPS receiver and a high-quality/stable oscillator for providing accurate clocking during GPS reception related functions. The GPS/DO unit 410 may be configured to drive one or more antennas 412 for use in receiving GPS (or any suitable global positioning system) signals. For example, the antennas 412 may be configured for multi-band L1/L2 based reception. Nonetheless, the disclosure is not limited to use of GPS, and as such any suitable global navigation satellite system (GNSS) may be used.

In some instances, the GPS/DO unit 410 may also be configured (e.g., by incorporating or otherwise configuring existing suitable circuitry) for providing on-board inertial measurements and multi-constellation positioning measurement. For example, the GPS/DO unit 410 comprise a combined on-board IMU sub-unit and multi-constellation GNSS positioning sub-unit.

The edge compute CPU/GPU 420 may comprise suitable circuitry for providing processing and related storage functions associated therewith. In this regard, the processing functions may include control and data processing (including video/graphics processing, such as video data obtained during sensory/detection operations). The edge compute CPU/GPU 420 may be configured for utilizing advance processing techniques, such as AI processing. For example, the edge compute CPU/GPU 420 may comprise, e.g., suitable circuity storing AI embedded software for handling AI based processing.

The network board 430 may comprise suitable circuitry for providing networking based communication, including both wireless (e.g., radio frequency (RF)) networking based communication and/or wired networking based communication (e.g., Ethernet). In this regard, the network board 430 may comprise at least one radio integrated circuit (IC), which may be configured to drive one or more antennas 432 for facilitating the radio based communications, such as cellular, WiFi, etc. In some instances, the antennas 432 may be configured for waveform MIMO 2.4 GHz based transmission/reception. The network board 430 may also comprise suitable circuitry for driving wired connector(s) (e.g., Cat5) 434, for facilitating wired based communications, such as, e.g., Ethernet based communications. The network board 430 may be configured to provide and/or support peer-to-peer (P2P) based communications.

The radar sensor 440 may comprise suitable circuitry (and related hardware resources) configured to provide radar detection. For example, the radar sensor 440 may be configured to operate as mmWave based radar. In this regard, the radar sensor 440 may comprise a millimeter phased array antenna 442, a signal transceiver 444, and a signal processor 446. Nonetheless, the disclosure is not limited to such approach, and any suitable radar detection technique may be used.

The optical sensor 450 may comprise suitable circuitry (and related hardware resources) configured to provide optical detection. For example, the optical sensor 450 may comprise an optical lens 452 and an image sensor 454.

The power management board 460 may comprise suitable circuitry (and related hardware resources) configured to provide power management functions within the sensor module 400.

The power module 470 may comprise suitable circuitry (and related hardware resources) configured for facilitating and/or supporting providing power to the sensor module 400. For example, the power module 470 may comprise a battery 472 that supplies power to the sensor module 400 for operation. In this regard, the battery 472 may be used in storing charge for supplying to the sensor module 400. The battery 472 may be a rechargeable battery. The power module 470 may further comprise DC-DC converter 474, which may be configured for converting input DC to one or more other DC values. For example, the input DC may be 12V (e.g., where the battery 472 may be a 12V battery), whereas some of the components of the sensor module 400 may require different voltages, such as 5V, and as such the DC-DC converter 474 may be configured to provide 5V within the sensor module 400 based on the 12V input DC.

In operation the sensor module 400 may be configured to provide sensory related functions, along with additional functions (e.g., communication, processing, etc.), and to do so specifically in mesh network comprising a plurality of mesh network nodes, where at least some of the mesh network nodes are mobile nodes, namely, drone based nodes (e.g., similar to the drone 300 described with respect to FIG. 3). In particular, the sensor module 400 may be configured to obtain or generate sensing data using sensory components embedded therein (or coupled thereto), such as the radar sensor 440, the optical sensor 450, etc. In this regard, the radars may provide long range and high-resolution 3D sensing, whereas the cameras (or other optical sensors) may provide short range and high accuracy object recognition. Further, other sensor types may be used, e.g., in plug-and-play manner, with the sensor module 400 being configured to support doing so.

Further, obtaining the sensing data may be optimize, which may include optimizing obtaining the sensing data even when the sensor module 400 is deployed in mobile platform (e.g., drone). In addition, the sensor module 400 may be configured to facilitate and/or support providing shared fields of view with respect to obtaining or generating sensing data, such as when operating with other sensor modules (e.g., each similar to the sensor module 400, but the disclose is not so limited) within the mesh network. This may be done by using multiple instances of the sensor module 400, which may be incorporated into multiple platforms (though, in some instances, multiple instances of the sensor module 400 may be incorporate into a same platform).

The sensor module 400 may also be configured to process at least some of the obtained sensing data, and/or to communicate with other entities (e.g., other sensors, mesh network nodes, etc.), such as to facilitate communication of sensing data and/or information obtained based thereon. In this regard, the sensor module 400 may be configured to provide fast real-time edge processing, e.g., to independently process radar and optical streams. In some instances, real-time object detection, classification, and tracking may be performed using AI based processing. In this regard, the edge compute CPU/GPU 420 may incorporate, e.g., high-performance embedded GPU and multi-core CPU that may be configured to run AI algorithms and associated software. The sensor module 400 may also be configured such that it may be modifiable to enable supporting other types of processors (or processing techniques), such as neuromorphic processors/processing, if needed.

With respect to communication functions, the sensor module 400 may utilize its networking capabilities (e.g., via the network board 430, and antennas 432 and/or Cat 5 connectors 434) to share sensing data over a private network. Communications can also be done using an external mesh (e.g., connected over SuperSpeed USB). Sharing of sensing data (and/or information obtained based thereon) may facilitate fusing of data within the network, and the sensor module 400 may be configured to facilitate and/or support such fusing of data. In this regard, distributed data fusion requires extremely accurate timing synchronization and position/pose information from all nodes. For example, the integrated GNSS timing hardware and proprietary time synchronization firmware and software may be used to enable each sensory unit to achieve high level of synchronization (e.g., sub-10 ns level synchronization), which may be similar to timing synchronization accuracy in 5G base stations. Further, the GPS/DO unit 410 may be used to provide accurate 3D coordinate and heading/rotation information required to combine detection and tracking from multiple sensor nodes.

In some instances, to further optimize operation in the sensor module 400, highspeed internal Ethernet and USB bus and connector(s) may be used therein connect all devices and components of the sensor module 400, such as at speeds of 1+Gbps.

FIG. 5 illustrates an example multi-modal sensor based network architecture, in accordance with an example embodiment of the disclosure. Shown in FIG. 5 is multi-modal sensor based network architecture 500, with sensor gateway in communication with network nodes, local resources and remote resources, which is configured for supporting multi-modal sensor solutions as described herein. In this regard, as noted, in some instances the multiple sensors may, alternatively, be all of one type (e.g., multiple radar sensors).

As illustrated in the example embodiment shown in FIG. 5, the multi-modal sensor based network architecture 500 comprises a sensor gateway 510, one or more sensor units 520, a local user interface (UI) 530, and a customer/cloud user interface (UI) 540.

The sensor gateway 510 may comprise suitable circuitry and other hardware resources for providing gateway related functions in multi-modal sensor based networks. For example, as shown in FIG. 5, the sensor gateway 510 may comprise a point-to-point or mesh (P2P/mesh) radio, GNSS radio (e.g., a GPS radio), a communication unit, processing unit(s), and a switch.

The P2P/mesh radio may be configured for enabling communications within a mesh network (e.g., with the sensor units 520, such as via corresponding P2P/mesh radio(s) therein). The GNSS radio may be configured for enabling GNSS related communications, such as reception of GNSS based signals, and processing thereof (e.g., to enable obtaining positioning related measurement). Nonetheless, in some instances, at least some of the processing may be performed in other components (e.g., the processing unit(s)).

The communication unit may be configured for facilitating and controlling communication functions, using wireless and/or wired based connections. As such, the communication unit may incorporate one or more wireless radios which may be configured to provide or support cellular connectivity (e.g., 4G/LTE, 5G, etc.) via cellular network(s), a WiFi access point for providing localized WiFi communication, etc. The communication unit may also incorporate a router configured for handling routing of data to and/or from the gateway. The communication unit may also be configured to provide virtual private network (VPN) client function to facilitate interactions with cloud server(s).

The processing unit(s) may be configured for providing processing and related storage functions associated therewith. In this regard, the processing functions may include control and data processing (including video/graphics processing, such as video data obtained during sensory/detection operations). For example, the processing unit(s) may comprise one or more CPUs, one or more GPUs, etc. The processing unit(s) may be configured for facilitating and controlling local interfaces, connectors, and ports (e.g., Ethernet, High-Definition Multimedia Interface (HDMI), USB, peripheral port(s), DC power, and the like (and peripheral devices connected thereto, if any, such as, e.g., keyboard, mouse, etc.). In some instances, the processing unit(s) may be configured for utilizing advanced processing techniques, such as AI processing. The switch may be configured for facilitating interactions among the various elements of the sensor gateway 510, particularly at high-speed (e.g., 1+Gbps).

Each of the sensor units 520 may comprise suitable circuitry and other hardware resources for providing edge sensing related functions in multi-modal sensor based networks. For example, as shown in FIG. 5, each sensor units 520 comprises a P2P/mesh radio, a GNSS (e.g., a GPS) radio, processing unit(s), a radar, and an optical sensor (e.g., camera). In this regard, the P2P/mesh radio may be configured for enabling communications within a mesh network (e.g., with the sensor gateway 510 and/or with other sensor units 520). The processor unit(s) may comprise one or both of CPU and GPU, and may be configured for providing processing and related storage functions associated therewith, including, inter alia, supporting and/or facilitating AI sensing, fusing, and sharing functions, as described herein. The GNSS radio may be configured for enabling GNSS related communications, such as reception of GNSS based signals, and to facilitate or support processing thereof (e.g., to enable obtaining positioning related measurement). The radar may be configured to provide radar detection (e.g., based on or using mmWave signals), whereas the optical sensor may be configured to obtain optical sensing data (e.g., videos or still images when the optical sensor is a camera).

The local UI 530 may comprise one or more local user/UI devices (e.g., mobile phones, tablets, personal computers, etc.). The customer/cloud UI 540 may comprise a virtual private cloud and one or more remote user/UI devices. The virtual private cloud may comprise one or more servers (and other systems) for providing VPN based cloud related services. For example, as shown in FIG. 5, the virtual private cloud may comprise VPN gateway server and an application (app) server.

In operation, the sensor gateway 510 may provide gateway functioning, e.g., bridging the sensor units 520 (and any mesh formed thereby) to local and/or remote user devices, and/or (optionally) providing connectivity within the mesh network, such as between different sensor units 520. Data available at the sensor gateway 510 may be aggregated, processed, and made available to the local UI 530 and/or customer/cloud UI 540. In this regard, the WiFi access point in the sensor gateway 510 may enable local user devices to utilize the sensor units, e.g., view live mission data, such as high-resolution streaming video, or radar tracking data. Further, the sensor gateway 510 may provide secure connectivity to remote devices, such as VPN connection(s). In this regard, the communication unit may be used in establishing a secure VPN tunnel to the VPN gateway of the customer/cloud UI 540, such as using cellular (e.g., 4G/LTE) links via the LTE radio. The virtual private cloud may then provide secure remote access by the remote user/UI devices. The same arrangement(s) may allow for control of the sensor unit 520 by the local user/UI devices (e.g., via the local WiFi access point, then through the switch and the P2P/mesh radio(s)) and/or the remote user/UI devices (e.g., via the VPN connection(s) over the 4G/LTE or 5G link(s), then through the switch and the P2P/mesh radio(s)).

In accordance with the present disclosure, the multi-modal sensor based network architecture 500 may be configured to provide collaborative network of multi-mode sensors for detecting and tracking objects, and for performing distributed hierarchical fusion of data, and edge computing as described herein. In this regard, as illustrated in FIG. 5, such multi-model sensor system may be deployed with more than one sensor unit 520 along with at least one sensor gateway 510, to enable providing enhanced sensing operations, e.g., extended range, different types of sensing data, aggregation of sensing data, etc. Each sensor unit 520 may have its own power source, and may be mounted adaptively or differently, e.g., on a pole, portable mast, vehicle, or other compatible structure, to enable continuous sensing of the environment. End-user devices connected to the sensor gateway 510 may receive sensing data and/or information based thereon, e.g., corresponding to sensor perception of observed environment tracking and identifying objects of interest.

Sensor units 520 and sensor gateway 510 at the edge are self-contained to sense the surroundings, fuse observations from sensors, identify and track object movements in real-time, locate in a 3D topographical map and communicating perception to end users.

The local UI 530 may allow local interfacing (e.g., via suitable physical interface via any suitable device) for managing the network of sensor units 520 as well as viewing real-time target data. The customer/cloud UI 540 may allow remote interfacing in similar manner. Using such interfacing capabilities, user(s) may, e.g., configure radar and optical sensing options, tune performance, update firmware/software, monitor status of devices and the network, as well as view live target detection, tracking, and classification data. If desired, the same data presented to a user can be accessed using the 3rd party application programming interface (API) enabling easy integration with other systems.

In some instances, AI processing may be used, such as in processing obtained sensing data, aggregating (or fusing) sensing data, etc. In this regard, AI processing on-board of sensor unit 520 performs object classification and tracking in real-time, using the communication to share processed sensor data with the sensor gateway 510. For example, the sensor gateway 510 regularly gathers feed from each sensor unit 520 preparing a unified view.

In some instances, target range or coverage area may be extended, such as simply by adding more sensor units 520 and/or more instance(s) of the sensor gateway 510. In this regard, such self-forming sensor network seamlessly adds units as long as they are in network reach, e.g., up to 1-mile between sensor and gateway.

The multi-modal sensor based network architecture 500 may enable users to maintain situational awareness of their surroundings. In this regard, the multiple sensor units 520 may be used in obtaining or generating sensing data, with the sensor gateway 510610 supporting edge computing (including fusing and/or aggregating of sensing data), and providing interfaces for both human and applications to interact with the sensor system as a whole. Sensor units 520 may be deployed adaptively, e.g., mounted statically (e.g., on a pole), on portable mast, or to a mobile platform, a vehicle, or a UAV-to sense the environment continuously. Each sensor unit 520 has optical and/or radar sensor to independently sense objects in real-time. The computing resources in the sensor unit(s) 520 and/or the sensor gateway 510 may be used to process sensor feeds locally. The GNSS (GPS) units may track sensor locations, and use that location information in tagging the sensing data with coordinate and time references. The communication service maintains stable link with the sensor gateway 510 communicating data and device operating status.

The sensor gateway 510 may utilized its computing, storage, advanced communication, and location services related resources to connect the sensor network with the users or other applications. The computing infrastructure (e.g., the processor(s) in the sensor gateway 510) may be used to run control applications administer and manage sensor units 520. The situational awareness applications provide continuous perception of the surroundings. The sensor gateway 510 supports an interactive user interface to enable connecting directly to observe the environment. Applications may communicate with the sensor gateway 510 over an open API using messages that allows third-parties to source and integrate sensing data with their applications. Third-party applications may use the sensing data deriving value-add usage, detecting friendlies and foes, safe-navigation, etc. The local UI 530 and/or the customer/cloud UI 540 may provide an interface for managing the network of sensor units 520 as well as viewing real-time target data. The UI connects securely to the sensor gateway 510 from handheld smart phones, tablets or PCs to observe environment and monitor the devices. In some instances, on-board GPUs in the sensor units 520 and the sensor gateway 510 may be configured to enable local AI processing mimicking human observer observing the environment sharing info with central command. In some instances, more sensor units 520 can be added to an existing sensor network to extend the coverage.

Again, it is to be appreciated that the particular arrangements of FIGS. 2 through 5 are presented by way of example only, to illustrate possible implementations of the central system 102 and sensor systems 104 of system 100 of FIG. 1.

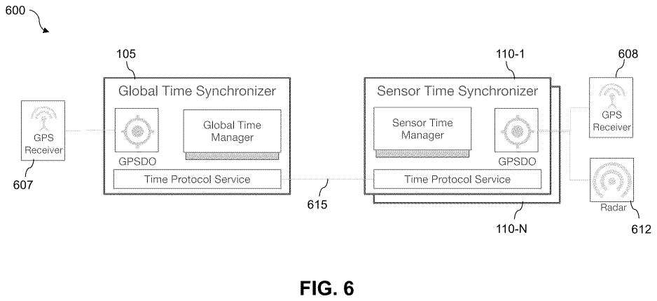

Additional details regarding the operation of the system 100 in illustrative embodiments will now be described below in conjunction with FIGS. 6 through 14.

Referring now to FIG. 6, a portion 600 of system 100 as shown comprises global time synchronizer 105 and local sensor time synchronizers 110-1 through 110-N. The global time synchronizer 105 is associated with a GPS receiver 607 of the central system 102, and each of the sensor time synchronizers 110 is associated with a different instance of a GPS receiver 608 and a radar 612 of the corresponding sensor system. Although only single instances of the GPS receiver 608 and the radar 612 are shown in FIG. 6 for clarity and simplicity of illustration, it is to be understood that each of the sensor systems 104 comprises separate instances of these components in illustrative embodiments. Moreover, in some embodiments, each of the sensor time synchronizers 110 as illustrated in FIG. 6 may be further associated with one or more additional radars and/or one or more other sensors of other types, as generally illustrated by the radar(s) 112 and other sensor(s) 114 of system 100 of FIG. 1. The particular example arrangement illustrated in FIG. 6 may therefore be viewed as one possible implementation of the more general arrangement illustrated in FIG. 1.

The global time synchronizer 105 comprises a GPSDO, a global time manager and a time protocol service as shown.

Similarly, each of the sensor time synchronizers 110 comprises a GPSDO, a sensor time manager and a time protocol service as shown. The time protocol service of the global time synchronizer 105 is configured to communicate with the time protocol service of each of the sensor time synchronizers 110 via respective instances of a network connection 615, which is illustratively a highly reliable connection such as a Transmission Control Protocol/Internet Protocol (TCP/IP) connection over one or more networks.

The global time manager in the global time synchronizer 105 directs the operation of the sensor time managers of the respective sensor time synchronizers 110. For example, the global time manager illustratively initializes a time synchronization process in which the sensor time managers and their corresponding sensors are synchronized to the first level of time synchronization (e.g., a millisecond scale). The sensor time managers then direct the local synchronization of the sensors of their corresponding sensor systems to the second level of time synchronization (e.g., a nanosecond scale), again under the control of the global time manager. The time protocol service components utilize a messaging protocol to facilitate the exchange of commands and other information between the global time manager and the sensor time managers. Such information can include, for example, commands such as start time synchronization and stop time synchronization, and related status information. The time protocol service components in some embodiments additionally support NTP functionality to permit communication with NTP servers within or otherwise accessible to the system 100.

The central system 102 comprising global time synchronizer 105 and the sensor systems 104 comprising respective sensor time synchronizers 110 illustratively provide a geographically-dispersed distributed sensor network which is capable of covering a large geographic area. Each of the sensor systems 104 comprises at least one radar 112 and may additionally or alternatively comprise one or more other types of sensors. The global time synchronizer 105 manages the overall synchronization process within the system 100. The global time synchronizer 105 and the sensor time synchronizers 110 include respective global and sensor time managers, which interact with one another to actively manage status of time synchronization, generation of clock signals, monitoring of clock signal drifts, and adjustments as needed to maintain time synchronization state for coordinated distributed sensing and other related data processing operations across all of the sensors of the system 100.

The global time synchronizer 105 collects GPS time signals from multiple GPS satellites via the GPS receiver 607. Corresponding clock and pulse signals are generated by the GPSDO. The global time manager utilizes these signals in controlling synchronization of the sensor systems 104 and their respective sets of sensors. This includes functions such as initiating timing synchronization within the system 100, maintaining a clock inventory for all connected sensor systems 104, monitoring synchronization status including time drifts of the clock signals, and initiating adjustment of the clock signals as needed.

Each of the sensor time synchronizers 110 includes a GPSDO driven by a corresponding GPS receiver 608, and is configured to control the timing synchronization of its radar 612, other radars and/or other sensors of other types within that sensor system. The sensor time synchronizers 110 in some embodiments support multiple distinct clock signals at different levels of precision for different types of sensors (e.g., nanosecond scale for radars and millisecond scale for optical sensors). The sensor time manager in each of the sensor time synchronizers 110 is responsible for functions such as receiving the local time reference from the GPS receiver 608, synchronizing time references with the global time synchronizer 105, monitoring for time drifts in the local sensor clock signals of its corresponding sensors, and initiating adjustments as needed in order to maintain the local clock signals within acceptable ranges.

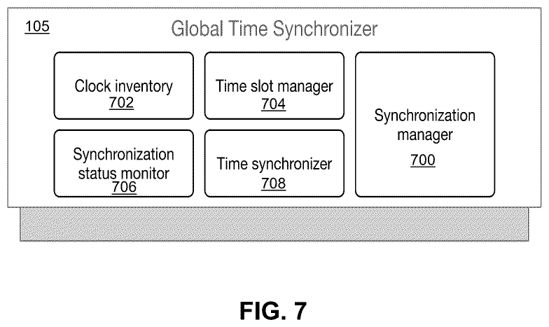

FIG. 7 shows a more detailed view of the global time synchronizer 105 of the central system 102 in an illustrative embodiment. The global time synchronizer 105 in this embodiment comprises a synchronization manager 700, a clock inventory 702, a time slot manager 704, a synchronization status monitor 706 and a time synchronizer 708. The particular example global time synchronizer components shown in this figure may be in addition to or in place of other example global time synchronizer components shown in other embodiments herein, such as the illustrative embodiment of FIG. 6. Other additional or alternative arrangements of global time synchronizer components can be used in other embodiments.

The synchronization manager 700 coordinates the operation of the clock inventory 702, the time slot manager 704, the synchronization status monitor 706 and the time synchronizer 708 within the global time synchronizer 105.

The clock inventory 702 illustratively comprises a database, implemented in a memory or other storage device of the central system 102, that maintains a list of all local sensor time synchronizers 110, including information such as their identifiers, profiles, location addresses, security, synchronization requirements and state of time synchronization.

The time slot manager 704 illustratively generates, maintains and publishes an operation schedule related to sensing operations and other data processing operations to be performed within the system 100, including allocation of particular time slots of one or more TDMA frames to particular sensors of the system 100. The operation schedule is updated periodically or under other conditions by the time slot manager 704 and published to each of the sensor time synchronizers 110 of the system 100.

The synchronization status monitor 706 is configured to monitor time synchronization state of each of the sensor time synchronizers 110 present in the system 100. For example, the synchronization status monitor is illustratively configured to compute time drifts, to predict or otherwise determine when a sensor time synchronizer may go out of synchronization, and to enforce policies related to time synchronization objectives within the system 100. The policy rules can be set and administered by users to achieve particular operational objectives of the distributed sensor network provided by the system 100.

The time synchronizer 708 initiates a time synchronization process to bring the distributed sensor network to a desired level of synchronization accuracy. For example, at startup of the sensor systems 104, the time synchronizer 708 interacts with the sensor time synchronizers 110 to initially achieve a coarse level of synchronization across the sensor time synchronizers 110. In cases in which a sensor system fails, a new sensor system joins the distributed sensor network, or one or more of the sensor systems exhibits an excessive amount of time drift, the time synchronizer 708 reinitiates the time synchronization process to initially bring the sensor time synchronizers 110 back into coarse synchronization. The sensor time synchronizers 110 are then further controlled to achieve a finer level of time synchronization (e.g., nanosecond scale) across all of their respective sensors.

In some embodiments, the synchronization manager 700 manages the process of starting and maintaining time synchronization for all of the sensor systems 104 having corresponding entries in the clock inventory 702. The synchronization manager 700 illustratively initiates a time synchronization process by sending a start synchronization command to the time synchronizer 708, which sends a corresponding command to each of the sensor systems 104. The synchronization manager 700 sends an additional command to the synchronization status monitor 706 to collect clock drifts reported from each sensor system. The time synchronizer 708 in some embodiments runs in a loop to collect the synchronization status obtained by the synchronization status monitor 706 from the sensor systems 104 and to detect above-threshold time drifts that trigger adjustments in synchronization. The time synchronizer 708 in some embodiments feeds the collected synchronization status to a machine learning algorithm that predicts the time drifts relative to a reference clock for comparison with one or more associated synchronization thresholds. Accordingly, embodiments that incorporate such a machine learning algorithm can predict the need for synchronization adjustments in advance. Numerous other techniques can be used by the time synchronizer 708 to detect excessive time drifts in one or more of the sensor systems 104 of the system 100. Once the thresholds for time synchronization have been met by each of the sensor systems 104, the system 100 continues to operate in synchronization until the time synchronizer 708 detects an above-threshold time drift.

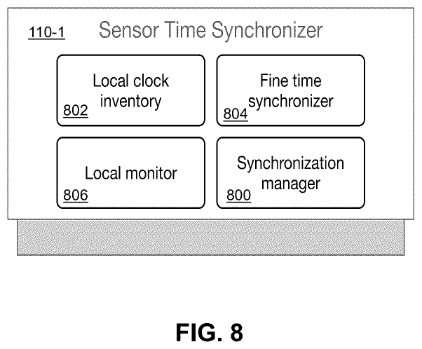

FIG. 8 shows a more detailed view of a particular one of the sensor time synchronizers 110, illustratively the sensor time synchronizer 110-1, in a corresponding one of the sensor systems 104 in an illustrative embodiment. The particular example sensor time synchronizer components shown in this figure may be in addition to or in place of other example sensor time synchronizer components shown in other embodiments herein, such as the illustrative embodiment of FIG. 6. Other additional or alternative arrangements of sensor time synchronizer components can be used in other embodiments.

The sensor time synchronizer 110-1 in this embodiment comprises a synchronization manager 800, a local clock inventory 802, a fine time synchronizer 804 and a local monitor 806.

The synchronization manager 800 coordinates the operation of the local clock inventory 802, the fine time synchronizer 804 and the local monitor 806 within the sensor time synchronizer 110-1.

The operation of the sensor time synchronizer 110-1 is generally similar to that of the global time synchronizer 105, but it is more particularly configured to maintain local time synchronization between its corresponding sensors to a finer level of time synchronization (e.g., nanosecond scale). Each of the sensor time synchronizers 110 further operates under the control of the global time synchronizer 105 to achieve the desired level of synchronization across all of the sensors of the system 100. For example, the radars 112 in some embodiments require nanosecond scale time synchronization, such as time synchronization to less than about 100 nanoseconds between the radars 112, and the sensor time synchronizers 110 operating in coordination with the global time synchronizer 105 can achieve that level of time synchronization across all of the radars 112 of the sensor systems 104.

The local clock inventory 802 illustratively comprises a database, implemented in a memory or other storage device of the corresponding sensor system, that maintains a list of all local sensors, such as radars 112 and other sensors 114, including information such as their identifiers, profiles, location addresses, security, synchronization requirements and state of time synchronization. The local clock inventory 802 in some embodiments more particularly comprises an inventory of the local clocks to be synchronized by the sensor time synchronizer 110-1.

The fine time synchronizer 804 is configured to implement a process for controlling the local clocks of the sensors of the corresponding sensor system to the desired level of time synchronization, illustratively a fine level of time synchronization (e.g., nanosecond scale), under the direction of the synchronization manager 800. Once the desired level of time synchronization is achieved, the process executing in the fine time synchronizer 804 sends a confirmation to the synchronization manager 800. In some embodiments, the fine time synchronizer 804 initiates the local time synchronization to achieve a level of time synchronization at or below about 100 nanoseconds between the sensors of the corresponding sensor system. As a more particular example, in some embodiments, a local phase-locked clock source provides a GPS-derived 1PPS signal and a corresponding 10 MHz clock signal to a radar. Processing circuitry within the radar utilizes the 10 MHz clock signal aligned to the 1PPS signal to achieve the fine level of time synchronization under the control of the fine time synchronizer 804. The fine time synchronizer 804 in some embodiments initiates the local time synchronization and continues to run as a process until the desired level of time synchronization is achieved across all of the sensors of the corresponding sensor system.

The local monitor 806 is configured to monitor clock drifts relative to reference clocks derived from GPS signals. This can include, for example, statistically measuring the periodic amount and direction of clock drift for each of the sensors, and applying policies based on one or more thresholds to generate time synchronization warnings. The local monitor 806 illustratively gathers synchronization status information from each of the sensors of the corresponding sensor system and reports it to the synchronization manager 800. Accordingly, the state of time synchronization in some embodiments is continuously fed to the synchronization manager 800 which can report it to the global time synchronizer 105.

The synchronization manager 800 ensures that the local clocks of the respective sensors of the corresponding sensor system are disciplined and maintained. It also ensures that assigned time slots are available for the sensors to conduct sensing and other data processing operations, and reports time synchronization status to the global time synchronizer 105.

The sensor time synchronizer 110-1 is configured via the above-described components to achieve and maintain local clock synchronization, across the sensors of the corresponding sensor system, within the threshold limits. It measures and reports local clock drifts to the global time synchronizer 105. For example, the synchronizer manager 800 in some embodiments can provide a local API endpoint for the local time synchronization functionality of the sensor time synchronizer 110-1. It can issue commands relating to achieving time synchronization between the local sensors, estimate the state of time synchronization across those sensors, and report synchronization status back to the global time synchronizer 105.

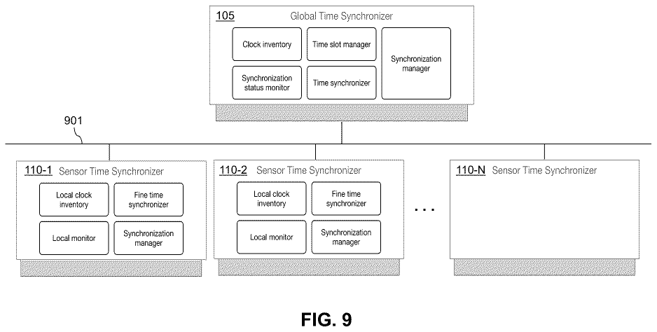

FIG. 9 illustrates the manner in which the global time synchronizer 105 is interconnected with the sensor time synchronizers 110 in an illustrative embodiment. In this embodiment, these components communicate with one another over one or more networks 901, which may represent a combination of multiple networks of different types. For example, the one or more networks 901 can comprise a global computer network such as the Internet, a wide area network (WAN), a local area network (LAN), a satellite network, a telephone or cable network, a cellular network such as a 4G or 5G network, a wireless network implemented using a wireless protocol such as Bluetooth, WiFi or WiMAX, or various portions or combinations of these and other types of communication networks.

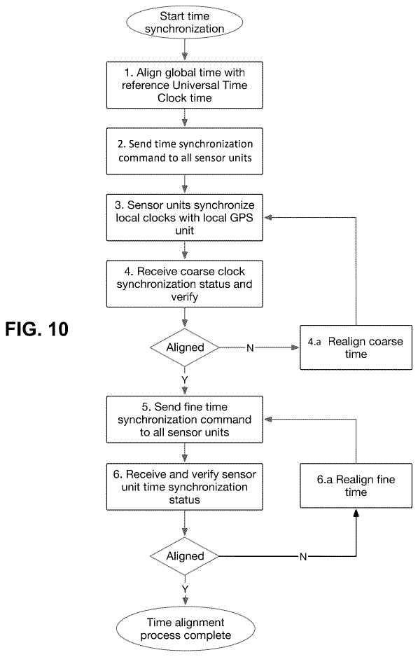

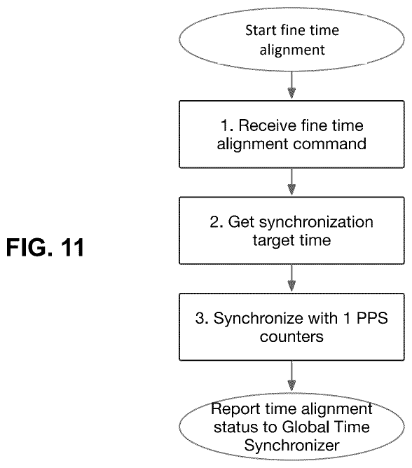

As indicated previously, the global time synchronizer 105 and the sensor time synchronizers 110 interact with one another to achieve a desired level of time synchronization across all of the sensors of the sensor systems 104. In some embodiments, the time synchronization process more particularly includes two distinct stages, namely, a coarse time alignment stage to achieve a relatively coarse level of time synchronization (e.g., millisecond scale) and a fine time alignment stage to achieve a relatively fine level of time synchronization (e.g., nanosecond scale), as will now be illustrated in conjunction with the flow diagrams of FIGS. 10 and 11, where FIG. 10 shows operations performed in the global time synchronizer 105, and FIG. 11 shows operations performed in each of the sensor time synchronizers 110. Other types and arrangements of time synchronization processes, synchronization levels and alignment process stages can be used in other embodiments.

FIG. 10 shows an example two-level time alignment process implemented in the global time synchronizer 105 in an illustrative embodiment. The process includes Steps 1 through 6 and associated coarse and fine alignment checks as shown.

At the start of the time synchronization process, in Step 1 the time synchronizer 708 in the global time synchronizer 105 initially aligns its global time with a reference Universal Time Clock (UTC) time. This illustratively involves the time synchronizer 708 aligning the global time of the global time synchronizer 105 to the corresponding GPSDO if available, or to network-based stratum-1 time server.

In Step 2, the time synchronizer 708 sends a time synchronization command to all sensor time synchronizers 110 of the sensor systems 104, also referred to herein as respective sensor units, directing those sensor units to start time synchronization. This command in some embodiments may include a target coarse time synchronization level to be achieved.

In Step 3, the sensor units synchronize their local sensor clocks with respective corresponding local GPS time references, illustrating each comprising a GPSDO driven by a GPS receiver. Local GPS time references are used independently at each sensor unit location to achieve faster and more accurate time synchronization while the global time synchronizer maintains the highest-level time reference within system 100.

In Step 4, the time synchronizer 708 receives and verifies coarse synchronization status from each of the sensor units. An associated coarse alignment check determines whether or not all of the sensor units are aligned in time within specified coarse alignment threshold limits. If all of the sensor units are not aligned within coarse alignment threshold limits, one or more adjustments are performed in Step 4.a to realign coarse time, and the process returns to Step 3 as indicated. After all of the sensor units are aligned within coarse alignment threshold limits, the process moves to Step 5 as indicated. Accordingly, Steps 3 and 4 are repeated in a loop until coarse time synchronization is achieved across all of the sensor units. The fine time synchronization portion of the process then begins in Step 5.

In Step 5, the time synchronizer 708 sends a fine time synchronization command to all the sensor units. This command in some embodiments may include a target fine time synchronization level to be achieved.

In Step 6, the time synchronizer 708 receives and verifies fine synchronization status from each of the sensor units. An associated fine alignment check determines whether or not all of the sensor units are aligned in time within specified fine alignment threshold limits. If all of the sensor units are not aligned within fine alignment threshold limits, one or more adjustments are performed in Step 6.a to realign fine time, and the process returns to Step 5 as indicated. After all of the sensor units are aligned within fine alignment threshold limits, the process is complete as indicated. Accordingly, Steps 5 and 6 are repeated in a loop until fine time synchronization is achieved across all of the sensor units.

The FIG. 10 process can be repeated in whole or in part under various conditions, such as loss of coarse or fine synchronization and/or the addition or removal of sensor units from the system 100.

FIG. 11 shows an example fine time synchronization process implemented in each of the sensor time synchronizers 110 in an illustrative embodiment. The process includes Steps 1 through 3 as shown, and may be repeated over multiple iterations until fine time alignment is achieved in the system 100.

At the start of the fine time synchronization process in the sensor time synchronizer of a given one of the sensor units, in Step 1 a fine time alignment command is received in a sensor time synchronizer of the given sensor unit from the time synchronizer 708 of the global time synchronizer 105. The fine time alignment command directs the sensor time synchronizer of the given sensor unit to start fine time synchronization.

In Step 2, a synchronization target time is obtained. For example, the synchronization target time may be extracted from the received fine time alignment command, or obtained in other ways, such as from another system component. In some embodiments, the synchronization target time comprises a time at which the global time synchronizer expects all the sensor unit clocks to be in synchronization.

In Step 3, the sensor time synchronizer attempts to synchronize utilizing 1PPS counters. Such counters illustratively count time steps each comprising a clock cycle of the 10 MHz clock signal relative to a particular pulse edge of the 1PPS signal. The use of a local GPS-based time reference in each sensor unit allows each of the sensors of that sensor unit to begin counting clock cycles from a common pulse edge of the 1PPS signal and therefore at substantially the same time, facilitating the achievement of the fine level of time synchronization between those sensors. The sensor unit in illustrative embodiments therefore utilizes its local GPS-based 1PPS signal and 10 MHz clock signal to attempt to reach fine time synchronization across its sensors in accordance with the synchronization target time.

After completion of Step 3, the sensor time synchronizer reports its time alignment status to the global time synchronizer 105.

The FIG. 11 process is performed over one or more iterations by each of the sensor units utilizing their respective sensor time synchronizers, and such time as all of the sensor unit clocks are synchronized at the fine time synchronization level. After such fine time synchronization is achieved, the sensor time synchronizers 110 of the respective sensor units each continue to report local time synchronization status to the global time synchronizer 105. The global time synchronizer 105 can detect above-threshold clock drifts or other time alignment differences that indicate a need for local or global resynchronization. Each of the sensor time synchronizers 110 can similarly detect such conditions among its local sensors and initiate local resynchronization as needed.

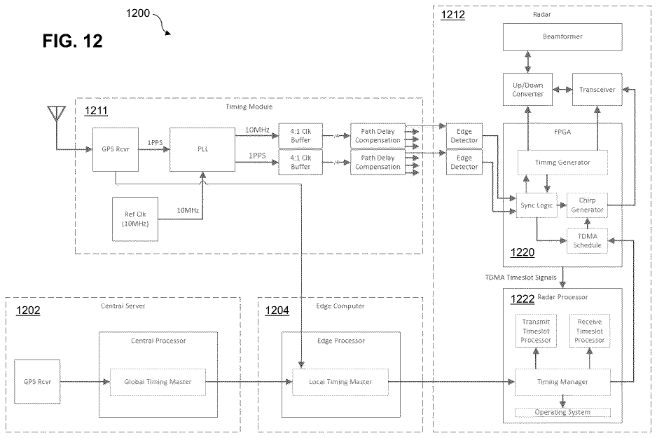

It is to be appreciated that the particular steps of the flow diagrams of FIGS. 11 and 12, and other flow diagrams herein, are presented by way of illustrative example only, and additional or alternative steps may be used in other embodiments. Also, the ordering of the steps can be varied relative to the particular orderings shown in the figures. For example, certain steps shown as being performed in serial order in a given flow diagram may instead be performed at least in part in parallel with one another in other embodiments.

In some embodiments, the above-described time synchronization process allows all of the sensors to operate in synchronization using assigned time slots of TDMA frames. This time synchronization arrangement advantageously avoids inter-sensor interference that could otherwise significantly degrade overall system performance. Moreover, the resulting synchronized network of distributed sensors can track objects with higher accuracy, precision and responsiveness than would otherwise be possible using conventional approaches. For example, in some embodiments, multiple sensors collaborate to perform sensing, and the improved time alignment achieved utilizing the techniques disclosed herein provides a significant reduction in time synchronization errors.

Referring now to FIG. 12, another example information processing system 1200 is shown. The system 1200 incorporates synchronization functionality for sensor systems with radars in an illustrative embodiment, utilizing time synchronization techniques similar to those described above.

The system 1200 comprises a central server 1202, an edge computer 1204, a local timing module 1211 and at least one radar 1212, arranged as shown.

The central server 1202 may be viewed as an example of what is more generally referred to herein as a “central system” and therefore may be viewed as one possible implementation of the central system 102 of system 100 in FIG. 1. A wide variety of other types and configurations of central systems may be used in other embodiments, and the term “central system” as used herein is therefore intended to be broadly construed.

The edge computer 1204, local timing module 1211 and radar 1212 may be viewed as comprising example portions of what is more generally referred to herein as a “sensor system” and therefore may be viewed as one possible implementation of the sensor system 104 of system 100 in FIG. 1. A wide variety of other types and configurations of sensor systems may be used in other embodiments, and the term “sensor system” as used herein is therefore intended to be broadly construed. The term “sensor” as used herein is similarly intended to be broadly construed and may comprise, for example, one or more radars and/or one or more other types of sensors of different modalities, such as an optical sensor, an IR sensor and a thermal sensor. Also, the term “radar” as used herein is intended to be broadly construed, and should not be viewed as being limited to any particular type of radar, such as a phased-array radar.

Although only a single such sensor system is shown in FIG. 12, the system 1200 may incorporate multiple such sensor systems, each comprising an edge computer, a local timing module and one or more radars and/or other sensors. Also, although only a single radar 1212 is shown in FIG. 12, the system 1200 may comprise multiple such radars within a given sensor system, each coupled to the same local timing module 1211 and edge computer 1204.

The central server 1202 in this embodiment comprises a GPS receiver coupled to a central processor. The central processor implements a global timing master, illustratively representing an example of the global time synchronizer 105 as previously described.

The edge computer 1204 in this embodiment comprises an edge processor that implements a local timing master, illustratively representing an example of one of the sensor time synchronizers 110 as previously described. The edge computer 1204 is coupled to the local timing module 1211 and to the radar 1212 as shown.

The timing module 1211 in this embodiment comprises a GPS receiver coupled to an antenna as shown, and a reference clock source. A 1PPS signal from the GPS receiver and a 10 MHz clock signal from the reference clock source are applied as inputs to a phase-locked loop (PLL) which phase locks the two signals and generates at its output phase-locked versions of the 1PPS signal and the 10 MHz clock signal, which are applied to respective 4:1 clock buffers, the outputs of which are subject to path delay compensation as shown before being applied to respective edge detectors of the radar 1212. The path delay compensation, which may be implemented as programmable delay lines, is illustratively used to compensate for different cable lengths between system components in a given deployment. The GPS receiver of the timing module 1211 also drives the local timing master in the edge computer 1204, although the edge computer 1204 in other embodiments can include its own local GPS receiver. Additionally or alternatively, the local timing master in the edge computer 1204 may be configured with access to a network-based stratum-1 time server. Also, other types of phase-locked sources can be used in the timing module 1211.

The radar 1212 in this embodiment comprises the above-noted edge detectors which receive the respective phase-locked 1PPS and 10 MHz signals from the timing module 1211, as well as a field-programmable gate array (FPGA) 1220, a radar processor 1222, an up/down converter, a transceiver and a beamformer, arranged as shown.

The FPGA 1220 illustratively comprises synchronization (“sync”) logic which receives the outputs of the edge detectors, and a timing generator, a chirp generator and a TDMA schedule component which are coupled to the sync logic. The timing generator drives the up/down converter and the transceiver as shown. The sync logic illustratively comprises one or more counters that are configured to count clock cycles of the 10 MHz clock signal relative to an edge of a pulse of the 1PPS signal.

The radar processor 1222 illustratively comprises a timing manager coupled to the local timing master of the edge computer 1204, and a transmit time slot processor, a receive time slot processor and an operating system, each coupled to the timing manager as shown.

The global timing master of central server 1202 interacts with the local timing master of the sensor system comprising edge computer 1204, timing module 1211 and radar 1212 to carry out a time synchronization process of the type previously described. For example, the global timing master and the local timing master collectively handle establishment of coarse time alignment (e.g., millisecond scale) and transition to fine time alignment (e.g., nanosecond scale) across a geographically-dispersed network of sensor systems each of which illustratively comprises an instance of edge computer 1204, timing module 1211 and radar 1212. Again, the FIG. 12 system is only an example, and a wide variety of other types and arrangements of sensors and other related components can be used in other embodiments. Also, it is possible that some sensor systems or corresponding sensors in the distributed sensor network may not be configured to achieve fine time alignment, for example, if the particular type of sensors in that sensor system do not require fine time alignment.

In the FIG. 12 system, GPS is used as the master clock source. This allows the different radars or other sensors in different sensor systems to be remotely located from one another, as a local GPS receiver and PLL in each sensor system maintains synchronization to the GPS satellite signal at each location. Using the phase-locked 10 MHz and 1PPS signals, each radar in a given sensor system is able to initially align its transmit and receive timing to a coarse boundary, illustratively a 1 second boundary based on the 1PPS signal, and then to a fine boundary, illustratively a 100 nanosecond or less boundary based on the 10 MHz signal. The transition from the coarse time synchronization to the fine time synchronization illustratively occurs after the radar has aligned to the coarse boundary, responsive to a command from the local timing master of the edge computer 1204 to synchronize at a particular time T=T₁. The radar determines the corresponding 1PPS boundary corresponding to that time, and begins counting clock cycles of the 10 MHz signal from the 1PPS boundary, denoted by a particular edge of a particular pulse of the 1PPS signal. The fine time alignment is based on a particular number of cycles of the 10 MHz signal relative to the particular edge of the particular pulse of the 1PPS signal. For example, a threshold for fine time alignment in some embodiments may be based at least in part on the particular number of cycles of the 10 MHz signal, such as one or more cycles. Other types of thresholds can be defined in other embodiments for use in detecting an above-threshold time alignment difference between radars.

This fine time alignment advantageously provides multiple geographically-dispersed radars with the ability to operate in a TDMA mode for both radar transmit and receive. For example, once this fine time synchronization is achieved based on the phase-locked 1PPS and 10 MHz signals, each radar is able to transmit and receive chirps within about 100 nanoseconds or less of each other. Other types of phase-locked signals provided by other types of phase-locked signal sources can be used in other embodiments.

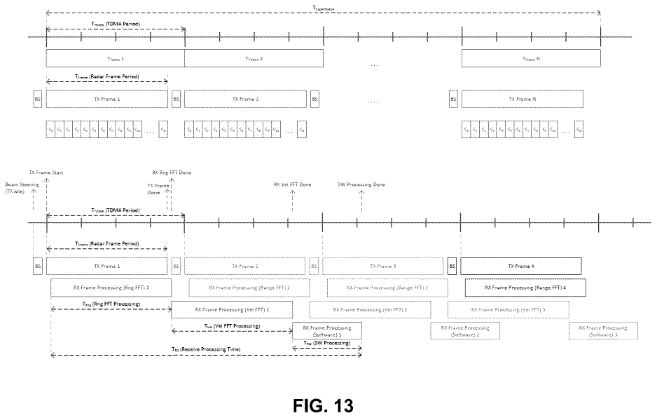

FIG. 13 is a timing diagram illustrating the manner in which TDMA time slots are synchronized across multiple sensor systems each comprising at least one radar in an illustrative embodiment. A TDMA superframe as shown in the upper portion of the figure is separated into multiple TDMA slots, denoted as respective TDMA periods 1, 2, . . . N. Different ones of the TDMA slots are illustratively assigned to different radars in different sensor systems which may be geographically dispersed. Each of the TDMA slots comprises a radar frame portion, denoted as a TX frame, and a beam stearing (BS) portion in which transmission is idle. A given radar transmits chirp signals illustratively denoted c₀ to c_{N} within the radar frame portion of its assigned TDMA slot or slots.

The lower portion of the figure illustrates the manner in which receive frame processing is performed relative to the TDMA slots in some embodiments. The receive frame processing in this example includes ranging (“Rng”) Fast Fourier Transform (FFT) processing, velocity (“Vel”) FFT processing and software (“SW”) processing, performed in sequential stages as illustrated. The receive frame processing for a given TX frame therefore extends beyond the duration of that TX frame, with different portions of that receive frame processing being overlapped with other portions of receive frame processing for other TX frames. For example, the ranging FFT processing for TX frame 2 partially overlaps the velocity FFT processing for TX frame 1, with similar overlaps for other receive frame processing portions for different ones of the TX frames. Such FFT and software processing is illustratively performed for a given receive frame at least in part in the FPGA 1220, radar processor 1222 and/or edge computer 1204 in the system 1200 of FIG. 12.

It is to be appreciated that the particular arrangement of TDMA slots and associated transmit and receive frame processing as shown in FIG. 13 is presented for purposes of illustration only. A wide variety of other timing arrangements utilizing the time synchronization techniques disclosed herein can be used.

Although GPS is utilized in illustrative embodiments described above, this is by way of example only. For example, in other embodiments, a single 10 MHz signal may be split using a signal splitter and provided to each of multiple radars using respective cables, where the radars are located in sufficiently close proximity to one another. One of the radars then creates a 1PPS signal using the 10 MHz source and distributes that 1PPS signal to the other radars nearby over respective cables. In such an embodiment, the 1PPS signal and 10 MHz signal at each radar can be aligned to within about 1 nanosecond, enabling highly synchronous operation which avoids any interference between the co-located radars.

As another example, a communication link may be used to distribute a timing signal to all radars, and a local clock circuit of each radar is configured to produce the 10 MHz and 1PPS signals from the timing signal. Again, highly synchronous operation between the radars can be achieved in such an embodiment.

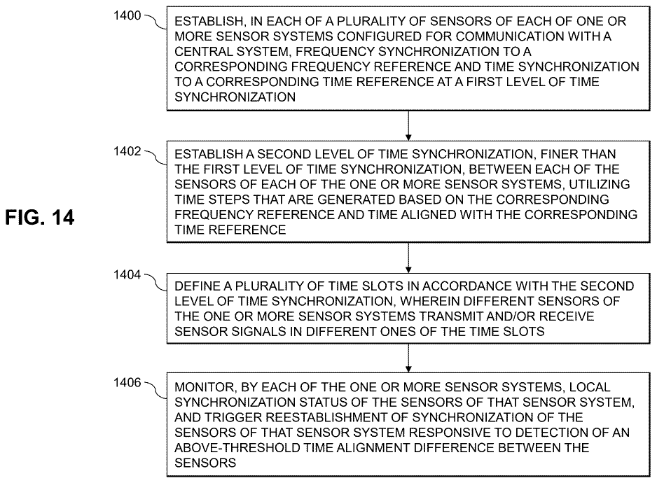

FIG. 14 shows another example of a synchronization process in an illustrative embodiment. This example process includes steps 1400 through 1406, and is illustratively performed by a distributed sensor network or other information processing system that includes a central system coupled to one or more sensor systems, such as central system 102 coupled to sensor systems 104 in system 100 of FIG. 1 or central server 1202 coupled to a sensor system comprising edge computer 1204, timing module 1211 and radar 1212 in system 1200 of FIG. 12. The process may be viewed as a synchronization algorithm performed by networked processing devices, each comprising at least one processor coupled to at least one memory.

Step 1400 includes establishing, in each of a plurality of sensors of each of one or more sensor systems configured for communication with a central system, frequency synchronization to a corresponding frequency reference and time synchronization to a corresponding time reference at a first level of time synchronization. In some embodiments, the central system comprises at least one of a central server and a central gateway in a distributed sensor network, and the one or more sensor systems comprise a plurality of geographically-dispersed sensor systems of the distributed sensor network. In some embodiments, the frequency reference and the time reference comprise respective phase-locked 10 MHz and 1PPS signals, although a wide variety of other signals can be used.

Step 1402 includes establishing a second level of time synchronization, finer than the first level of time synchronization, between each of the sensors of each of the one or more sensor systems, utilizing time steps that are generated based on the corresponding frequency reference and time aligned with the corresponding time reference.

Step 1404 includes defining a plurality of time slots in accordance with the second level of time synchronization, wherein different sensors of the one or more sensor systems transmit and/or receive sensor signals in different ones of the time slots. In some embodiments, the time slots comprise TDMA slots of a TDMA frame. For example, the sensor systems may comprise respective radars with each of the radars transmitting and receiving one or more chirp signals within one or more assigned ones of the time slots. Other types and arrangements of time slots can be used in other embodiments.

Step 1406 includes monitoring, by each of the one or more sensor systems, local synchronization status of the sensors of that sensor system, and triggering reestablishment of synchronization of the sensors of that sensor system responsive to detection of an above-threshold time alignment difference between the sensors. For example, in some embodiments, the local synchronization status of a given one of the sensors of one of the sensor systems illustratively comprises sensor timing information determined based at least in part on a count of cycles of a clock signal relative to a designated pulse of a pulse signal, and detection of an above-threshold time alignment difference is based at least in part on the sensor timing information. Other types of local synchronization status information and associated above-threshold alignment difference detection techniques may be used in other embodiments.

In some embodiments, additional monitoring is performed by the central station. For example, the central station is illustratively configured to monitor global synchronization status across the one or more sensor systems, and to trigger reestablishment of synchronization of at least one of the one or more sensor systems responsive to detection of an above-threshold time alignment difference between the central system and the at least one of the one or more sensor systems.

These particular steps are presented by way of illustrative example only, and should not be viewed as limiting in any way. As indicated previously, in other embodiments, additional or alternative steps may be used, and the ordering of the steps can be varied relative to the particular ordering shown in the figure. For example, certain steps shown as being performed in serial order in the figure may instead be performed at least in part in parallel with one another in other embodiments.

Illustrative embodiments provide significant advantages over conventional approaches to timing synchronization.

For example, some embodiments provide techniques for synchronization across multiple sensor systems, one or more of which may comprise multi-modal sensor systems having multiple distinct sensor modalities.

The disclosed techniques can illustratively provide highly accurate time synchronization between transmit “chirps” across the multiple radars of the multi-modal sensor systems, as well as communication signals associated with the other sensor modalities, in some cases to an accuracy on the order of nanoseconds.

These and other embodiments can advantageously support highly accurate coordinated tracking across different fields of view of the multi-modal sensor systems, even when the sensor systems are geographically dispersed relative to one another, while also avoiding the above-noted drawbacks of conventional approaches.

Some embodiments advantageously combine detection signals across all of the sensors in a common coordinate system to treat the entire sensor network as a single field of view. These and other embodiments can extend the range of the distributed sensor network, while also increasing its accuracy and resiliency, and simplifying tracking handoffs.

In some embodiments, a time synchronization process of the type disclosed herein allows all of the sensors of a distributed sensor network to operate in synchronization using assigned time slots of TDMA frames. This time synchronization arrangement advantageously avoids inter-sensor interference that could otherwise significantly degrade overall system performance. Moreover, the resulting synchronized network of distributed sensors can track objects with higher accuracy, precision and responsiveness than would otherwise be possible using conventional approaches.

Some embodiments disclosed herein implement time synchronization techniques that provide multiple geographically-dispersed radars with the ability to operate in a TDMA mode for both radar transmit and receive, with nanosecond scale time alignment between the different radars.

The above-noted features and advantages of illustrative embodiments may or may not be present in other embodiments.

The central system 102 and the sensor systems 104 of system 100, and the central server 1202 coupled to a sensor system comprising edge computer 1204, timing module 1211 and radar 1212 in system 1200 of FIG. 12, are illustratively implemented using one or more processing platforms each comprising at least one processing device, where a given such processing device may comprise a computer, server or other processing device, or combinations of multiple processing devices. Such computers, servers or other processing devices each illustratively comprise at least one processor coupled to a memory.

For example, the central system 102 and the sensor systems 104 may be implemented on respective different processing platforms. A given one of the central system 102 and the sensor systems 104 may also be distributed over multiple processing platforms, each comprising one or more processing devices. Terms such as “processing platform” as used herein are therefore intended to be broadly construed.

The above-noted processing platforms can each include multiple processing devices. Examples of such processing devices include computers or servers comprising respective processors and associated memory, or other types of processing devices. Storage devices such as storage arrays or cloud-based storage systems used for implementing databases herein are also considered “processing devices” as that term is broadly used herein.

The processing devices can be configured to communicate over one or more networks. The one or more networks can comprise, for example, a global computer network such as the Internet, a WAN, a LAN, a satellite network, a telephone or cable network, a cellular network such as a 4G or 5G network, a wireless network implemented using a wireless protocol such as Bluetooth, WiFi or WiMAX, or various portions or combinations of these and other types of communication networks.

A processing platform in some embodiments comprises at least one processor, at least one memory and at least one network interface. The processor is assumed to be operatively coupled to the memory and to the network interface. The term “processor” as used herein is therefore intended to be broadly construed.

The processor in some embodiments may comprise, for example, a microprocessor, a CPU, a GPU, an FPGA, an application-specific integrated circuit (ASIC), a system-on-chip (SOC), a neural processing unit (NPU), a data processing unit (DPU), a tensor processing unit (TPU), an arithmetic logic unit (ALU), a digital signal processor (DSP), or other similar processing device component, as well as other types and arrangements of processing circuitry, in any combination.

At least a portion of the functionality of at least one of the central system 102 and the sensor systems 104 and their respective associated timing synchronization algorithms provided by one or more processing devices as disclosed herein can be implemented using such circuitry.

In some embodiments, the processor comprises one or more graphics processor integrated circuits. Such graphics processor integrated circuits are illustratively implemented in the form of one or more GPUs. Accordingly, in some embodiments, system 100 is configured to include a GPU-based processing platform. Such a GPU-based processing platform can be at least partially cloud-based and is illustratively configured to implement one or more machine learning systems in conjunction with the timing synchronization functionality disclosed herein. Similar arrangements can be implemented using one or more CPUs, NPUs, DPUs, TPUs and/or other processing devices, in any combination.

A memory illustratively stores software program code for execution by a corresponding processor in implementing portions of the functionality of the processing platform. For example, at least portions of the functionality of at least one of central system 102 and sensor systems 104 can be implemented using program code stored in one or more memories of one or more processing devices.

A given such memory that stores such program code for execution by a corresponding processor is an example of what is more generally referred to herein as a processor-readable storage medium having program code embodied therein, and may comprise, for example, electronic memory such as SRAM, DRAM or other types of random access memory, flash memory, read-only memory (ROM), magnetic memory, optical memory, or other types of storage devices in any combination.

Articles of manufacture comprising such processor-readable storage media are considered embodiments of the present disclosure. The term “article of manufacture” as used herein should be understood to exclude transitory, propagating signals.

Other types of computer program products comprising processor-readable storage media can be implemented in other embodiments.

In addition, illustrative embodiments may be implemented in the form of integrated circuits comprising processing circuitry configured to implement processing operations associated with the central system 102 and the sensor systems 104 as well as other related functionality. For example, at least a portion of the functionality of a given such central system or sensor system is illustratively implemented in at least one integrated circuit of a processing device of the processing platform.

The network interface is configured to allow the processing platform to communicate over one or more networks with other system elements, and may comprise one or more conventional transceivers.

It is to be appreciated that the particular arrangements of components and other system elements shown in FIGS. 1 through 14 are presented by way of illustrative example only, and numerous alternative embodiments are possible. For example, other embodiments of information processing systems can be configured to implement timing synchronization functionality of the type disclosed herein.

Accordingly, although illustrative embodiments are described in the context of particular central system and sensor system configurations, it is to be appreciated that the disclosed techniques can be adapted in a straightforward manner to a wide variety of other distributed sensing configurations.

Also, information processing systems with timing synchronization functionality as disclosed herein can be configured to support a wide variety of distinct applications, in numerous diverse contexts. References herein to particular applications, such as multi-modal sensor systems with radars and implemented utilizing AI drones, are therefore presented by way of illustrative example only, and the disclosed techniques can be adapted for use in any of a wide variety of other contexts.

The various embodiments disclosed herein should therefore not be construed as limiting in any way. Numerous alternative arrangements of central systems, sensor systems, sensors and timing synchronization processes can be utilized in other embodiments. Those skilled in the art will also recognize that a wide variety of alternative processing operations and associated system configurations can be used in other embodiments.

An information processing system with synchronization functionality as disclosed herein may be implemented using one or more processing platforms, or portions thereof.

For example, one illustrative embodiment of a processing platform that may be used to implement at least a portion of an information processing system comprises cloud infrastructure including virtual machines implemented using a hypervisor that runs on physical infrastructure. Such virtual machines may comprise respective processing devices that communicate with one another over one or more networks.

The cloud infrastructure in such an embodiment may further comprise one or more sets of applications running on respective ones of the virtual machines under the control of the hypervisor. It is also possible to use multiple hypervisors each providing a set of virtual machines using at least one underlying physical machine. Different sets of virtual machines provided by one or more hypervisors may be utilized in configuring multiple instances of various components of the information processing system.

Another illustrative embodiment of a processing platform that may be used to implement at least a portion of an information processing system as disclosed herein comprises a plurality of processing devices which communicate with one another over at least one network. Each processing device of the processing platform is assumed to comprise a processor coupled to a memory.

Again, these particular processing platforms are presented by way of example only, and an information processing system may include additional or alternative processing platforms, as well as numerous distinct processing platforms in any combination, with each such platform comprising one or more computers, storage devices or other processing devices.

A given processing platform implementing at least a portion of a central system and/or a sensor system as disclosed herein can run on or be otherwise supported by cloud infrastructure or other types of virtualization infrastructure.

It should therefore be understood that in other embodiments different arrangements of additional or alternative elements may be used. At least a subset of these elements may be collectively implemented on a common processing platform, or each such element may be implemented on a separate processing platform.

Also, numerous other arrangements of computers, servers, storage devices or other components are possible in an information processing system. Such components can communicate with other elements of the information processing system over any type of network or other communication media.

As indicated previously, components of the system as disclosed herein can be implemented at least in part in the form of one or more software programs stored in memory and executed by a processor of a processing device. For example, certain functionality disclosed herein can be implemented at least in part in the form of software.

The particular configurations of information processing systems described herein are exemplary only, and a given such system in other embodiments may include other elements in addition to or in place of those specifically shown, including one or more elements of a type commonly found in a conventional implementation of such a system.

For example, in some embodiments, an information processing system may be configured to utilize the disclosed techniques to provide additional or alternative functionality in other contexts.

It should again be emphasized that the embodiments of the present disclosure as described herein are intended to be illustrative only. Other embodiments of the present disclosure can be implemented utilizing a wide variety of different types and arrangements of information processing systems, central systems, sensor systems, radars and/or other sensors and associated processing devices than those utilized in the particular illustrative embodiments described herein, and in numerous alternative distributed sensing contexts. In addition, the particular assumptions made herein in the context of describing certain embodiments need not apply in other embodiments. These and numerous other alternative embodiments will be readily apparent to those skilled in the art.

What is claimed is:

1. A method comprising:
establishing, in each of a plurality of sensors of each of one or more sensor systems configured for communication with a central system, frequency synchronization to a corresponding frequency reference and time synchronization to a corresponding time reference at a first level of time synchronization;
establishing a second level of time synchronization, finer than the first level of time synchronization, between each of the sensors of each of the one or more sensor systems, utilizing time steps that are generated based on the corresponding frequency reference and time aligned with the corresponding time reference;
defining a plurality of time slots in accordance with the second level of time synchronization, wherein different sensors of the one or more sensor systems transmit and/or receive sensor signals in different ones of the time slots; and
monitoring, by each of the one or more sensor systems, local synchronization status of the sensors of that sensor system, and triggering reestablishment of synchronization of the sensors of that sensor system responsive to detection of an above-threshold time alignment difference between the sensors.

3. The method of claim 1 wherein the central system and one or more the sensor systems comprise respective nodes of a distributed sensor network.

4. The method of claim 1 wherein the central system comprises at least one of a central server and a central gateway.

5. The method of claim 1 wherein the one or more sensor systems comprise a plurality of geographically-dispersed sensor systems.

5. The method of claim 1 further comprising:
monitoring, by the central system, global synchronization status across the one or more sensor systems; and
triggering reestablishment of synchronization of at least one of the one or more sensor systems responsive to detection of an above-threshold time alignment difference between the central system and the at least one of the one or more sensor systems.

6. The method of claim 1 wherein the local synchronization status of a given one of the sensors of one of the sensor systems comprises sensor timing information determined based at least in part on a count of cycles of a clock signal relative to a designated pulse of a pulse signal, and detection of an above-threshold time alignment difference is based at least in part on the sensor timing information.

7. The method of claim 1 wherein the central system comprises a global time synchronizer configured to communicate with sensor time synchronizers of respective ones of the one or more sensor systems, the sensor time synchronizer of a given one of the sensor systems being configured to control each of the sensors of the given sensor system to achieve the second level of time synchronization.

8. The method of claim 1 wherein each of the one or more sensor systems comprises:
a clock source configured to lock to the corresponding time reference; and
an edge computer coupled to the clock source and implementing a corresponding sensor time synchronizer;
wherein the sensors of the sensor system comprise at least one radar coupled to the edge computer and the clock source.

9. The method of claim 1 wherein the central system and the one or more sensor systems each comprise at least one of a Global Positioning System (GPS) receiver and a Network Time Protocol (NTP) unit.

10. The method of claim 1 wherein each of the one or more sensor systems comprises a phase-locked clock source providing a pulse signal and a clock signal, where the first level of time synchronization is established by the sensors of the corresponding sensor system based at least in part on the pulse signal and the second level of time synchronization is established by the sensors of the corresponding sensor system based at least in part on respective counts of cycles of the clock signal relative to a designated pulse of the pulse signal.

11. The method of claim 10 wherein the pulse signal comprises a one pulse per second (1PPS) signal and the clock signal comprises a 10 MHz clock signal.

12. The method of claim 1 wherein the time slots comprise time-division multiple access (TDMA) slots of a TDMA frame.

13. The method of claim 1 wherein the sensor systems comprise respective radars and each of the radars transmits and receives one or more chirp signals within one or more assigned ones of the time slots.

14. The method of claim 1 wherein at least a subset of the sensor systems comprise respective multi-modal sensor systems that each include at least one radar and at least one additional sensor of a different sensor modality.

15. A distributed system comprising:
a central system; and
one or more sensor systems, each comprising a plurality of sensors and being configured to communicate with the central system;
wherein the distributed system is configured:
to establish, in each of the plurality of sensors of each of the one or more sensor systems configured for communication with the central system, frequency synchronization to a corresponding frequency reference and time synchronization to a corresponding time reference at a first level of time synchronization;
to establish a second level of time synchronization, finer than the first level of time synchronization, between each of the sensors of each of the one or more sensor systems, utilizing time steps that are generated based on the corresponding frequency reference and time aligned with the corresponding time reference;
to define a plurality of time slots in accordance with the second level of time synchronization, wherein different sensors of the one or more sensor systems transmit and/or receive sensor signals in different ones of the time slots; and
to monitor, by each of the one or more sensor systems, local synchronization status of the sensors of that sensor system, and to trigger reestablishment of synchronization of the sensors of that sensor system responsive to detection of an above-threshold time alignment difference between the sensors.

16. The distributed system of claim 15 wherein the one or more sensor systems comprise a plurality of geographically-dispersed sensor systems.

17. The distributed system of claim 15 wherein the distributed system is further configured:
to monitor, by the central system, global synchronization status across the one or more sensor systems; and
to trigger reestablishment of synchronization of at least one of the one or more sensor systems responsive to detection of an above-threshold time alignment difference between the central system and the at least one of the one or more sensor systems

18. The distributed system of claim 15 wherein each of the one or more sensor systems comprises:
a clock source configured to lock to the corresponding time reference; and
an edge computer coupled to the clock source and implementing a corresponding sensor time synchronizer;
wherein the sensors of the sensor system comprise at least one radar coupled to the edge computer and the clock source.

19. The distributed system of claim 15 wherein the central system is implemented at least in part on a same processing platform as at least one of the sensor systems.

20. A computer program product comprising a non-transitory processor-readable storage medium having stored therein program code of one or more software programs, wherein the program code, when executed by at least one processing device, causes the at least one processing device:
to establish, in each of a plurality of sensors of each of one or more sensor systems configured for communication with a central system, frequency synchronization to a corresponding frequency reference and time synchronization to a corresponding time reference at a first level of time synchronization;
to establish a second level of time synchronization, finer than the first level of time synchronization, between each of the sensors of each of the one or more sensor systems, utilizing time steps that are generated based on the corresponding frequency reference and time aligned with the corresponding time reference;
to define a plurality of time slots in accordance with the second level of time synchronization, wherein different sensors of the one or more sensor systems transmit and/or receive sensor signals in different ones of the time slots; and
to monitor, by each of the one or more sensor systems, local synchronization status of the sensors of that sensor system, and to trigger reestablishment of synchronization of the sensors of that sensor system responsive to detection of an above-threshold time alignment difference between the sensors.
